(19) United States
(12) Patent Application Publication
(10) Pub. No.: US 2023/0108313 A1
(43) Pub. Date: Apr. 6, 2023

(54) DATA TRIAGE IN MICROSCOPY SYSTEMS

(71) Applicant: FEI COMPANY, Hillsboro, OR (US)

(72) Inventors: Bradley J. Larson, Hillsboro, OR (US); Ondrej Machek, Hillsboro, OR (US); Katherine M. LaChasse, Hillsboro, OR (US)

(21) Appl. No.: 17/957,445

(22) Filed: Sep. 30, 2022

Related U.S. Application Data
(60) Provisional application No. 63/251,351, filed on Oct. 1, 2021.

(51) Int. Cl. G06V 10/77; G06V 10/94; G06V 10/74; G06V 10/776; G06V 10/778

(52) U.S. Cl. CPC G06V 10/7715; G06V 10/95; G06V 10/761; G06V 10/776; G06V 10/7788; G06V 2201/06

(57) ABSTRACT

Disclosed herein are scientific instrument support systems, as well as related methods, computing devices, and computer-readable media. For example, in some embodiments, a support apparatus is provided for a scientific instrument. The support apparatus s configured to generate, using a machine-learning model, one or more identified features in an image of a set of images acquired via a scientific instrument. The support apparatus is also configured to determine whether the set of images satisfies one or more selection criteria and assign the set of images, including the one or more identified features, to a training dataset in response to a determination that the set of images satisfies the one or more selection criteria. The support apparatus is also configured to retrain the machine-learning model using the training dataset. A method performed via a computing device for providing scientific instrument support is also provided.

### RELATED APPLICATIONS

This application claims priority under 35 U.S.C. § 119(e) to U.S. Provisional Application No. 63/251,351, filed Oct. 1, 2021, the entire content of which is incorporated by reference herein.

### FIELD

Microscopy is the technical field of using microscopes to better view objects that are difficult to see with the naked eye. Different branches of microscopy include, for example, optical microscopy, charged particle (e.g., electron and/or ion) microscopy, and scanning probe microscopy. Charged particle microscopy involves using a beam of accelerated charged particles as a source of illumination. Types of charged particle microscopy include, for example, transmission electron microscopy, scanning electron microscopy, scanning transmission electron microscopy, and ion beam microscopy.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1A is a block diagram of an example scientific instrument support apparatus for performing support operations, in accordance with various embodiments.

FIG. 1B is a block diagram of data triage logic of the support apparatus of FIG. 1A, in accordance with various embodiments.

FIG. 1C is a block diagram of model promotion logic of the support apparatus of FIG. 1A, in accordance with various embodiments.

FIG. 2A is a flow diagram of an example method of performing support operations, in accordance with various embodiments.

FIG. 2B is a flow diagram of an example method of performing data triage operations as part of the method of FIG. 2A, in accordance with various embodiments.

FIG. 2C is a flow diagram of an example method of performing model promotion operations as part of the method of FIG. 2A, in accordance with various embodiments.

FIG. 3 is an example image including a plurality of identified features generated using a machine-learning model for an image.

FIG. 4 is an example plot depicting a number of features identified per image in a set of images.

FIG. 5 is an example plot depicting a feature area per image in a set of images.

FIG. 6 is an example plot depicting feature distances identified per image in a set of images.

FIG. 7 is an example plot depicting a number of features identified per image in a set of images, wherein the example plot represents an unsuccessful machine-learning inference.

FIG. 8 is an example plot depicting a feature area per image in a set of images, wherein the example plot represents an unsuccessful machine-learning inference.

FIG. 9 is an example plot depicting feature distances identified per image in a set of images, wherein the example plot represents an unsuccessful machine-learning inference.

FIG. 10 is an example user interface for receiving selection criteria from a user, in accordance with various embodiments.

FIG. 11 is an example user interface for providing training results of a machine-learning model, in accordance with various embodiments.

FIGS. 12 and 13 are example plots depicting performance metrics of a machine-learning model, in accordance with various embodiments.

FIG. 14 depicts a graph of example performance metrics of a plurality of machine-learning models, in accordance with various embodiments.

FIG. 15 depicts example model deployment criteria associated with a particular scientific instrument for registering with the machine-learning server, in accordance with various embodiments.

FIG. 16 is an example user interface for manually deploying machine-learning models, in accordance with various embodiments.

FIG. 17 is an example of a graphical user interface that may be used in the performance of some or all of the support methods disclosed herein, in accordance with various embodiments.

FIG. 18 is a block diagram of an example computing device that may perform some or all of the scientific instrument support methods disclosed herein, in accordance with various embodiments.

FIG. 19 is a block diagram of an example scientific instrument support system in which some or all of the scientific instrument support methods disclosed herein may be performed, in accordance with various embodiments.

FIG. 20 is a block diagram of an example scientific instrument included in the scientific instrument support system, in accordance with various embodiments.

### DETAILED DESCRIPTION

Disclosed herein are scientific instrument support systems, as well as related methods, computing devices, and computer-readable media. For example, in some embodiments, a scientific instrument support apparatus for a scientific instrument (e.g., a charged particle microscope) is provided. The scientific instrument support apparatus, which may be implemented by a common computing device included in the scientific instrument or remote from the scientific instrument, is configured to generate, using a machine-learning model, one or more identified features in an image of a set of images acquired via the scientific instrument. The scientific instrument support apparatus is also configured to determine whether the set of images satisfies one or more selection criteria. The scientific instrument support apparatus is also configured to assign the set of images, including the one or more identified features, to a training dataset in response to a determination that the set of images satisfies the one or more selection criteria. The scientific instrument support apparatus is also configured to retrain the machine-learning model using the training dataset. A method performed via a computing device for provided scientific instrument support is also provided.

The scientific instrument support embodiments disclosed herein may achieve improved performance relative to conventional approaches. For example, machine-learning (ML) models (implementing one or more ML algorithms) have demonstrated improvements in, among other things, target image localization, endpoint identification, and image quality improvement as compared to earlier methods. ML model performance, however, is often dependent on training the model with similar images to those the model will encounter during use or deployment. While there are large open datasets for human-scale features (e.g., people, vehicles, and animals), such datasets are not available for most microscope features due to, for example, the specialized equipment, samples, and structures common in microscopy. Consequently, machine learning requires microscope data produced by users for training. This data, however, may be used in proprietary or intellectual property (IP) sensitive applications (e.g., semiconductor microscopy), which controls access to the data, and, in some implementations, such data is only available at the user or customer site and not available to entities equipped to build and train (including retrain) models using machine learning. In addition to access restrictions, having users produce training data creates inefficiencies. For example, having users annotate large sets of data consumes large amounts of user time and computing resources, may introduce human errors (e.g., given that the process is laborious and monotonous), and, in many situations, is infeasible given the amount of available training data needing annotation or labeling for use as training data. For example, many scientific instruments generate thousands of images per day. The embodiments disclosed herein thus provide improvements to scientific instrument technology (e.g., improvements in the computer technology supporting such scientific instruments, among other improvements).

The embodiments disclosed herein may achieve improved machine-learning models and associated data processing with such models relative to conventional approaches. For example, as noted above, conventional approaches strictly rely on user production of training data. However, as noted above, these approaches suffer from a number of technical problems and limitations, including inefficient use of computing resources for producing such training data manually and limitations due to access controls associated with proprietary data at a particular site.

Various ones of the embodiments disclosed herein may improve upon conventional approaches to achieve the technical advantages of improved machine-learning models and, consequently, improved operation of scientific instruments through improved inference (e.g., identification of one or more features in image data) using the models on acquired data, such as, for example, data acquired via microscopes, including, for example, charged particle microscopes (CPMs). For example, scientific instruments, such as, for example, CPMs, act as a data source by generating output data, such as image data. This generated output may be used as a data source to improve machine-learning performance by moving the machine-learning workflow to an end user (e.g., a customer), wherein this workflow may be repeated as new data becomes available (new image data from one or more CPMs) to retain accuracy and reliability through a changing process. In particular, by automatically selecting useful output (e.g., microscope images) as training data (i.e., determining which output data will benefit future machine learning) this output may be feed back into the machine-learning process at the customer level while continuing to protect proprietary and intellectual property rights in the data. For example, embodiments described herein may automatically select useful output (e.g., one or more images or one or more sets of images) generated by one or more scientific instruments (e.g., microscopes) and present the output for human review and annotation (e.g., through one or more user interfaces), wherein the annotated data may be used as training data to retrain a model and does not require that the user have expertise in machine learning. The automatic selection of such useful data prevents prompting a user to review and annotate all available data, which makes more efficient use of computing resources and results in more accurate machine-learning models (e.g., improved effectiveness in edge cases, which may be identified and presented to users for human review and annotation). The selected training data is subsequently used to improve the machine-learning model, which results in improved operation and performance of a scientific instrument or a processing involving the scientific instrument, such as, for example, improved sample preparation, sample processing (e.g., milling), image diagnosis, machine configuration and operation, or the like.

In other words, embodiments described herein automatically triage data output by one or more scientific instruments to generate training data for one or more machine-learning models to optimize the value of such training data while minimizing human effort and protecting access controls associated with such data. Such technical advantages are not achievable by routine and conventional approaches, and all users of systems including such embodiments may benefit from these advantages (e.g., by assisting the user in the performance of a technical task, such as, for example, endpointing, by means of an improved machine learned model). The technical features of the embodiments disclosed herein are thus decidedly unconventional in the field of microscopy and other scientific instruments, as are the combinations of the features of the embodiments disclosed herein. As discussed further herein, various aspects of the embodiments disclosed herein may improve the functionality of a computer itself; for example, an inference computer used via a scientific instrument to apply a model to control or guide operation of the scientific instrument, prepare or process a sample, perform a diagnosis, configure or calibrate the scientific instrument, or the like. The computational and user interface features disclosed herein do not only involve the collection and comparison of information but apply new analytical and technical techniques to change the operation of a scientific instrument through the use of an improved model acquired via an improved learning process. The present disclosure thus introduces functionality that neither a conventional computing device, nor a human, could perform.

Accordingly, the embodiments of the present disclosure may serve any of a number of technical purposes, such as controlling a specific technical system or process; determining from measurements how to control a machine; digital audio, image, or video enhancement or analysis; or a combination thereof. In particular, the present disclosure provides technical solutions to technical problems, including but not limited to generation of machine-learning models for use in operation of scientific instruments, such as, for example, CPMs.

The embodiments disclosed herein thus provide improvements to scientific instrument technology (e.g., improvements in the computer technology supporting scientific instruments, such as for example, microscopes including CPMs, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

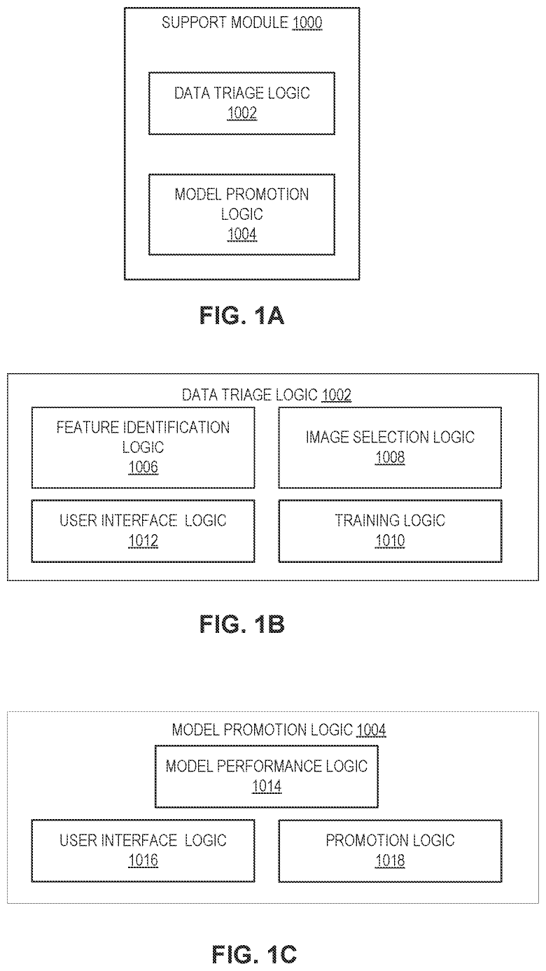

FIG. 1A is a block diagram of an example scientific instrument support module 1000 for performing support operations for a scientific instrument in accordance with various embodiments. As one non-limiting example, the scientific instrument support module 1000 is described herein as supporting a CPM and hence is also referred to herein as the “CPM support module 1000.” The data triaging, model promotion, or both described herein is applicable to various types of scientific instruments employing machine-learning models to generate inferences (a diagnosis inferred from image data, such as, for example, one or more features identified in an image), and embodiments described herein are not limited to CPM support. For example, the data triaging and model promotion described herein as being performed by the CPM support module 1000 may be used in electron cryotomography applications, gene sequencing applications, and other microscope and imaging applications using inferences from machine-learning models.

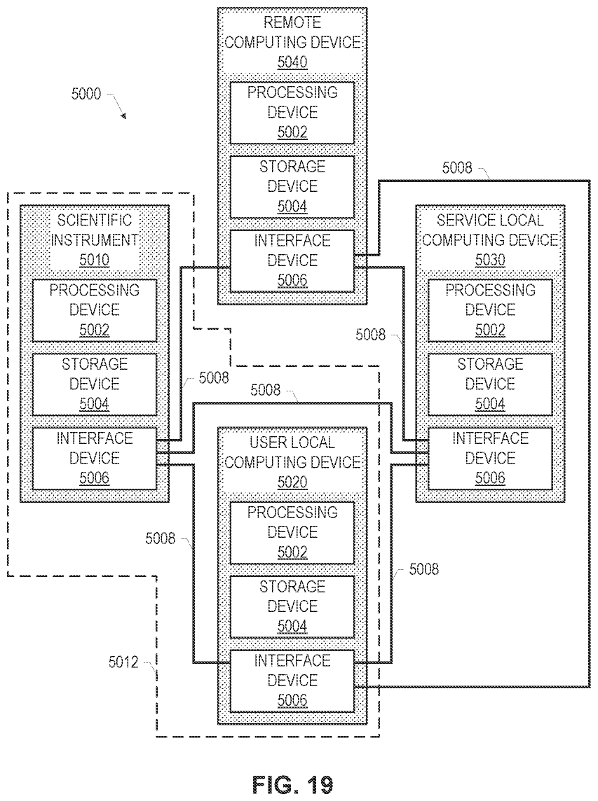

The CPM support module 1000 may be implemented by circuitry (e.g., including electrical and/or optical components), such as a programmed computing device. The logic of the CPM support module 1000 may be included in a single computing device or may be distributed across multiple computing devices that are in communication with each other as appropriate. Examples of computing devices that may, singly or in combination, implement the CPM support module 1000 are discussed herein with reference to the computing device 4000 of FIG. 18, and examples of systems of interconnected computing devices, in which the CPM support module 1000 may be implemented across one or more of the computing devices, are discussed herein with reference to the scientific instrument support system 5000 of FIG. 19.

As described in more detail below, the CPM support module 1000 implements a ML workflow that uses previous inferences generated by a machine-learning model to improve future inferences generated by the model, wherein the CPM support module 1000 performs automated data triage to identify what previous inferences to include in the ML workflow and how to include such previous inferences in the ML workflow to efficiently create effective machine-learning models for a customer. The ML workflow may include collecting data, creating training datasets, retraining models, testing and validating models (as retrained), promoting and deploying models, or a combination thereof. The CPM support module 1000 may repeat the ML workflow as new data becomes available to implement a continuous learning workflow, which improves a machine-learning model based on incoming data (e.g., from one or more CPMs) and subsequently improves performance of the CPM and potentially other scientific instruments and processes (e.g., preparation of a sample accurately via the CPM). As used herein, “continuous” learning or a “continuous” workflow generally means that a training process (i.e., retraining) is repeated for a machine-learning model, such as, for example, when new data becomes available or other triggering events occur. This repeated training includes performing automated data triaging, wherein the automated nature of this data triaging requires limited user intervention and user experience or expertise in machine-learning processes, which allows the learning workflow to be implemented at a customer or client level (e.g., an owner or operator of one or more scientific instruments, such as one or more CPMs) while respecting data controls or access limitations.

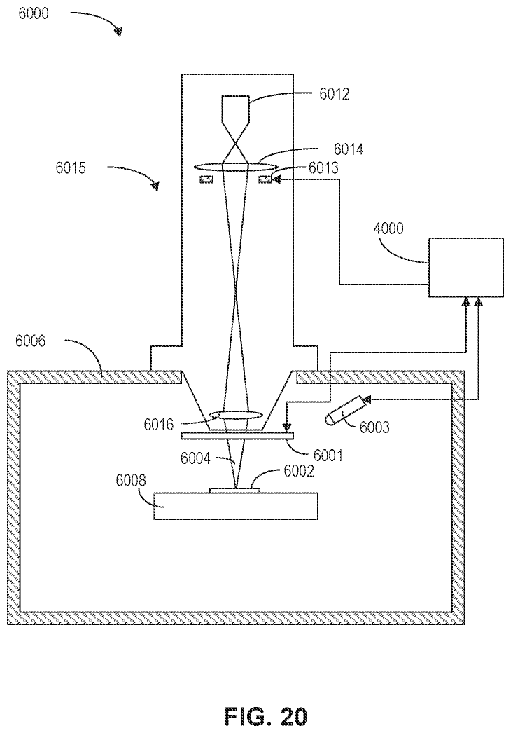

For example, as described in more detail below with respect to FIG. 20, a CPM generates a set of images of a sample, wherein the set of images includes one or more images. A machine-learning model is applied to the set of images to determine one or more identified features within the set of images (also sometimes referred to herein as “inferences”). The one or more identified features may include stage detection, line indicated termination runs, device line endpointing, griderator, image denoising, or similar image features or artifacts. The inferences may be made available for future training of the machine-learning model. However, as noted above, including all inferences in future training (without manual review or annotation) may reduce the effectiveness of the machine-learning model, especially with respect to edge cases, and may require significant computing resources (e.g., memory and processing resources) given the volume of image data and associated inferences generated. However, having a user manually review, triage, and annotate (as needed) all such available inferences requires significant overhead, which in many situations, is cost prohibitive. Furthermore, providing available inferences to a third-party for use in further model training, such as a party skilled in machine learning, may limit the availability training data as some customers are hesitant or restricted in sharing image data, inferences generated from such image data, or both with other customers or organizations and lack in-house experience in machine-learning workflows and training, which limits available data for subsequent training and improvement of the machine-learning model.

Accordingly, the CPM support module 1000 performs automated data triage to identify whether and how to feed images (as processed via the machine-learning model to generate one or more inferences) back into a learning workflow for the machine-learning model. In some embodiments, the CPM support module 1000 also optionally manages machine-learning models to control when a model is promoted by determining model performance and automatically deploying models for use based on such performance. For example, as illustrated in FIG. 1A, the CPM support module 1000 may include data triage logic 1002 and, optionally, model promotion logic 1004. As used herein, the term “logic” may include an apparatus that is to perform a set of operations associated with the logic. For example, any of the logic elements included in the support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The data triage logic 1002 may perform any of the data triage operations discussed herein. For example, the data triage logic 1002 may automatically identify data helpful to a machine-learning workflow and incorporate the identified data into the machine-learning workflow accordingly. As noted above, data triaging reduces the overhead required in learning workflows by reducing the number of user annotations and other manual processing steps required. Also, as described in more detail below, the data triage logic 1002 integrates the learning workflow into a customer's workflow to allow a customer access to and control over the learning workflow for their models without requiring the customer to share image data or inferences with other customers and without requiring that the customer has experience or expertise in machine-learning processes. For example, the data triage logic 1002 may deploy model learning at a customer site level (e.g., at a server owner or operated on behalf of the customer) and may advantageously require a small amount of user overhead, present a clearly understood process (without requiring that the customer have experience or training in machine-learning processes), and provide reliable results.

FIG. 1B is a block diagram of the data triage logic 1002 according to some embodiments. As illustrated in FIG. 1B, in some embodiments, the data triage logic 1002 includes feature identification logic 1006, image selection logic 1008, training logic 1010, and user interface logic 1012. As noted above, logic implemented via the CPM support module 1000 (including the data triage logic 1002) may be included in a single computing device or may be distributed across multiple computing devices that are in communication with each other as appropriate. For example, in some embodiments, the feature identification logic 1006 may be performed via one or more computing devices included in or local to the scientific instrument, such as, for example, via an inference computer included in or local to the CPM. The image selection logic 1008, the training logic 1010, and the user interface logic 1012 may be performed via a computing device remote from the CPM, such as at a server communicating with one or more CPMs over one or more communication networks. For example, in some embodiments, CPMs may generate image data and apply (e.g., via a local inference computer) one or more machine-learning models to generate the inferences as described herein for the feature identification logic 1006, wherein the image data and inferences are transmitted to one or more servers applying the image selection logic 1008, training logic 1010, and user interface logic 1012. In this sample configuration, the user interface logic 1012 may generate user interfaces provided on one or more user local computing devices. Additional details regarding computing device configurations applicable to the CPM support module 1000 and the logic associated therewith are provided below with respect to FIGS. 18 and 19.

The feature identification logic 1006 may generate, using a machine-learning model, one or more identified features in a set of images, such as, for example, a set of images generated via a CPM. As noted above, the one or more identified features may include stage detection, line indicated termination runs, device line endpointing, griderator, image denoising, or similar image features or artifacts.

The image selection logic 1008 determines whether the set of images satisfies one or more selection criteria to control whether or how the set of images is incorporated into the learning workflow for the machine-learning model. In some embodiments, the image selection logic 1008 may determine whether a set of images satisfies the one or more selection criteria by generating a set of metrics for the one or more identified features associated with the set of images, wherein a set of images satisfies the one or more selection criteria in response to one or more metrics included in the set of metrics satisfying one or more predetermined thresholds (also referred to as references). In addition to or as an alternative to using metrics of individual images or individual sets of images (e.g., associated with the same sample or imaging session), the image selection logic 1008 may look at patterns or correlations among multiple sets of images to determine whether a set of images (or a portion thereof) satisfy the one or more selection criteria. Identifying correlations or patterns, such as, for example, changes or trends in the metrics of image sets over time, may identify changing conditions that may warrant new training of the machine-learning model. Also, in some embodiments, the selection criteria are associated with random selections, such as, for example, selecting every 100th generated set of images and associated identified features for inclusion in the learning workflow. In addition to selecting what images to include in the learning workflow, the image selection logic 1008 may designate or flag images, including the associated inferences (i.e., the one or more identified features generated via the machine-learning model), for inclusion in one or more different training datasets within the learning workflow. As used herein, a “training dataset” includes a set of images used as part of the machine learning workflow described herein and, as described herein, in some embodiments, the workflow uses multiple different training datasets. For example, in some embodiments, the training datasets include a retraining dataset, an annotation dataset, a testing dataset, and a validation dataset, and the image selection logic 1008 may automatically assign (e.g., designate or flag) one or more images and their associated inferences for inclusion in one or more of these training datasets. It should be understood, however, that embodiments described herein may use fewer or additional datasets or different types of datasets than those described herein. In the example types of training datasets described herein, the retraining dataset may include images and associated inferences used to retrain a model, and the testing dataset and the validation dataset are used to test and validate the model, as retrained, respectively. The annotation dataset may be stored and images included in the annotation dataset may be made available for manual review (e.g., by an operator of the CPM, a process engineer, or other users), wherein one or more user interfaces are provided that allow a user to review an image or set of images and associated inferences (using one or more visualization and navigation tools), annotate one or more images as needed, include or exclude an image from the learning process, specify a training dataset for one or more images within the learning workflow, or a combination thereof. In some embodiments, the image selection logic 1008 initiates one or more alerts (e.g., electronic messages, such as, for example, email messages, text messages, chat messages, or the like) when one or more images are available for manual review within the annotation dataset. The alerts may include one or more selectable links (e.g., selecting uniform resource locators (URLs)) for accessing one or more user interfaces (described below) providing access to one or more images included in the annotation dataset for manual review.

The selection criteria may be based on metrics of the one or more identified features (e.g., anomalies detected within an image or a set of images as compared to a base or reference), patterns or correlations over sets of images, random selections, or a combination thereof. Also, in some embodiments, the selection criteria may be customized for a particular user or user-site, through one or more user-defined rules, which may be defined through one or more user interfaces provided via the CPM support module 1000.

The training logic 1010 applies one or more of the training datasets established via the data triaging performed with the feature identification logic 1006 and image selection logic 1008 to train the machine-learning model. In some embodiments, the training logic 1010 controls when training is performed. The training logic 1010 may trigger training of a model based on various conditions, such as, for example, the availability of annotations correcting inference errors included in a training dataset (e.g., determined based on a similarity between an inference and an annotation), a predetermined increase (e.g., percentage) in a size of a training dataset, a predetermined (e.g., percentage) increase in annotations of a specific feature, an availability of training resources, or based on a manually-launched training job.

In response to determining to train a model with one or more available training datasets, the training logic 1010 may perform training in accordance with a training configuration. Features of the training configuration may include one or more of which algorithms to train, initial transfer learning models to use, training sources (e.g., choice of hardware and amount of parallelism (batch size, ROI size, GPUs & nodes), training stop conditions (e.g., number of training epochs, rate of convergence, lack of convergence, or the like), or a combination thereof. All or some features of the training configuration may be manually defined by a user through one or more user interfaces provided via the CPM support module 1000.

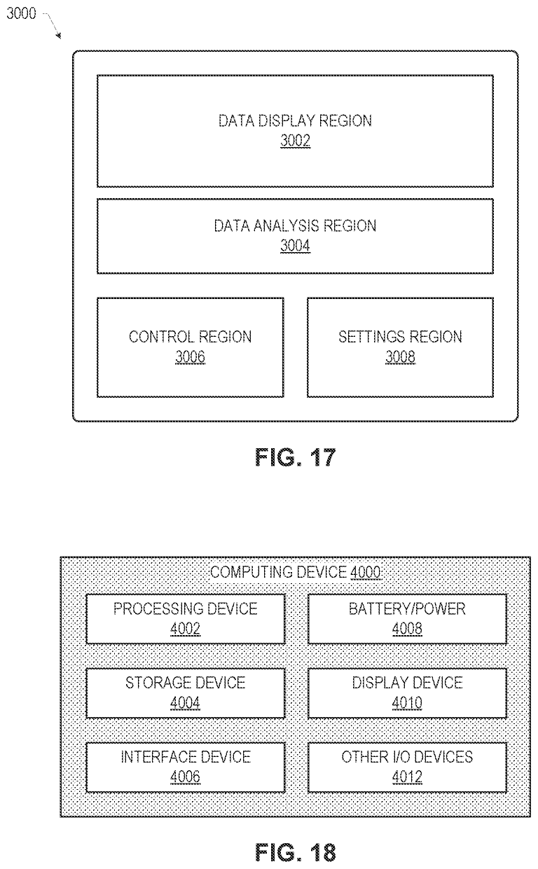

The user interface logic 1012 generates one or more user interfaces associated with the functionality performed via the data triage logic 1002. As described in more detail below, the one or more user interfaces may provide visualization, annotation, and selection and designation tools for reviewing image data included in the annotation dataset by the image selection logic 1008. These user interfaces allow a user to review images, review inferences associated with the images, add annotations, exclude an image from the learning workflow, include an image in the learning workflow, designate an image as being included in a particular training dataset of the learning workflow, or a combination thereof. As described below with respect to FIG. 17, these user interfaces may display image data in the data display region 3002, may display inferences associated with the image data, metrics associated with such inferences, or a combination thereof, in the data analysis region 3004, and may display options for annotating, excluding, including, or designating image data within the scientific instrument control region 3006, the settings region 3008, or a combination thereof.

In some embodiments, the user interface logic 1012 also generates one or more user interfaces presenting options for configuring (setting and/or changing) the data triaging performed via the data triage logic 1002. For example, the user interface logic 1012 may generate one or more user interfaces for configuring selection criteria applied by the image selection logic 1008, configuring training trigger conditions applied by the training logic 1010, configuring training configurations applied by the training logic 1010, or a combination thereof.

User interfaces generated via the user interface logic 1012 may include various access permissions that allow or limit user interactions with data or options included in the user interface. For example, in some embodiments, only users with particular access permissions may be allowed to review images included in the annotation dataset, annotate images included in the annotation dataset, configure selection criteria, configure training aspects, or the like. These access permissions may be implemented to control access to data (e.g., only users associated with a particular customer may view image data collected via instruments associated with the customer) as well as control what users may configure the CPM support module 1000 and its associated functionality. In some embodiments, the user interface logic 1012 may be distributed among multiple logic modules (e.g., a first user interface logic, a second user interface logic, etc.), wherein each logic module may generate and provide one or more specific user interfaces (e.g., specific user interfaces for particular output, input options, access permissions, etc.).

As noted above with respect to FIG. 1A, in some embodiments, the CPM support module 1000 also includes model promotion logic 1004. FIG. 10 is a block diagram of the model promotion logic 1004 according to some embodiments. The model promotion logic 1004 may perform any of the model promotion operations discussed. As illustrated in FIG. 10, in some embodiments, the model promotion logic 1004 includes model performance logic 1014, user interface logic 1016, and promotion logic 1018.

The model performance logic 1015 generates one or more performance metrics for machine-learning models. The performance metrics may be based on training or testing performance of a model.

The promotion logic 1018 deploy, based on the performance metrics of the machine-learning models, a particular machine-learning model to one or more scientific instruments, such as to one or more CPMs. The promotion logic 1018 may compare performance metrics across models and may rank candidate models based on tests results, deployment performance, or a combination thereof. The promotion logic 1018 may optionally be manually supervised. For example, through the promotion logic 1018, a user may enable specific models to be deployed (e.g., for process stability or to screen new models). For automated deployment, the promotion logic may select the best model for a particular step of a target process and may record what models are deployed where to ensure clear records of model deployment. In some embodiments, when automated promotion, including automated deployment, is used, a level of automation may be set by a user. Automated promotion, including automated deployment, reduces time commitments often associated with model deployments as well as associated effort and expertise in performing such deployment. Also, the ML workflow described herein may be used to create well-functioning models that improve progressively, wherein automated promotion ensures such improvement is deployed appropriately to ensure newer and better performing models are used when available. In addition, the promotion process and the ability for a user to configure the process and see results of the process (e.g., performance metrics, inferences, ranks, deployments, etc.) provides an observable process where executing models are known, the process is clear, the results are understandable, and inferences are clear.

The promotion logic 1018 may perform model promotion in one or more user-customizable promotion steps such as, for example, “Prototype”, “Qualified,” and “Production.” Each step may be associated with particular threshold scores, wherein a score for a model may be based on model loss (tracked during model training), model testing (tracked during model testing or validating), and model deployment (tracked during use of a model, such as based on metrics described above for inferences generated by a deployed mode). In some embodiments, the components to a score may be weighted differently within a step, differently across steps, or a combination thereof.

For example, the promotion logic 1018 may apply promotion criteria to identify when to promote a model to a particular step. The promotion criteria may include the weighted scores as described above. The promotion criteria may include other parameters, such training set size, training time or frequency, or the like. The promotion criteria may be set by a user through one or more user interfaces, which may be generated via the user interface logic 1016. The user interface logic 1016 may also generate one or more user interfaces that allow a user to manually promote (including deploy) a specific model to one or more instruments. The user interface logic 106 may also generate one or more interfaces for reviewing or troubleshooting performance of a model, such as by providing inferences generated by a model for particular image data (e.g., with various visualization and navigation tools). As described above with respect to the user interface logic 1012, user interfaces generated via the user interface logic 1016 may include various access permissions that may allow or limit user interactions with data or options included in the user interface. For example, in some embodiments, only users with particular access permissions may be allowed to set promotion criteria, review or troubleshoot model performance, manually promote (including deploy) models, or the like. Again, these access permissions may be implemented to control access to data (e.g., only users associated with a particular customer may view image data collected via instruments associated with the customer) as well as control what users may configure the CPM support module 1000 and its associated functionality. In some embodiments, the user interface logic 1016 may be distributed among multiple logic modules (e.g., a first user interface logic, a second user interface logic, etc.), wherein each logic module may generate and provide one or more specific user interfaces (e.g., specific user interfaces for particular output, input options, access permissions, etc.).

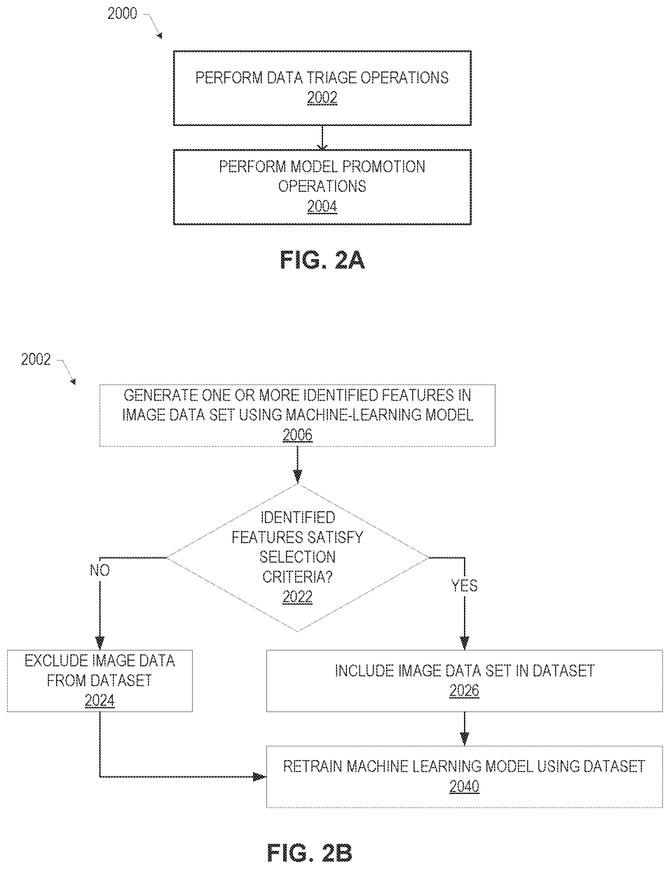

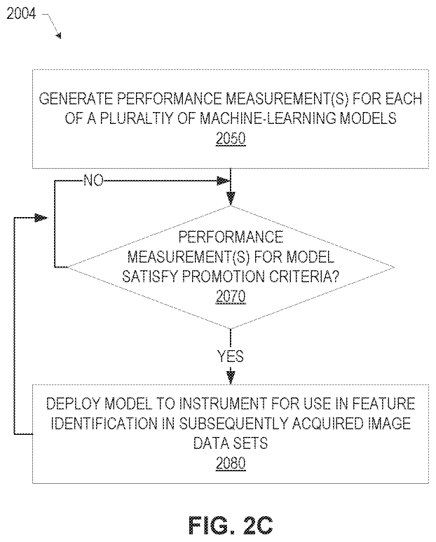

FIG. 2A is a flowchart representing a method 2000 performed by the CPM support module 1000. Although the operations of the method 2000 may be illustrated with reference to particular embodiments disclosed herein (e.g., the CPM support module 1000 or logic included therein, the graphical user interface 3000, the computing devices 4000, and/or the scientific instrument support system 5000), the method 2000 may be used in any suitable setting to perform any suitable support operations. Each block of method 2000 is illustrated once each and in a particular order in FIG. 2A, however, the operations may be reordered and/or repeated as desired and appropriate (e.g., different operations performed may be performed in parallel, as suitable).

As described below, the method 2000 represents a support method of a scientific instrument, such as, for example, a CPM, and a machine-learning model applied by such an instrument. The method 2000 is described herein with respect to a CPM. However, as noted above, the method 200 may be used with other types of scientific instruments, including other types of microscopes or imaging equipment. Also, is should be understood that prior to executing the method 2000, a scientific instrument (e.g., a CPM) may be appropriately prepared and configured for operation. For example, a sample may be selected and placed into a holder in a chamber of the CPM. The CPM (or an associated computing device) may also be loaded with a machine-learning model configured to generate one or more inferences (i.e., identified features) within images generated by the CPM of the sample.

As illustrated in FIG. 2A, the method 2000 includes performing data triage operations (at block 2002, such as via the data triage logic 1002) and, optionally, performing model promotion operations (at block 2004, such as via the model promotion logic 1004). The method 2000 may include some or all of the operations described in reference to FIG. 2A. For example, the method 2000 may include performing both the data triage operations (at block 2002) and the model promotion operations (at block 2004). In other embodiments, however, the method 2000 may include just performing the data triaging operations (at block 2004) and not the model promotion operations (at block 2004). Similarly, in some embodiments, the method 2000 may include just performing the model promotion operations (at block 2004) and not the data triage operations of (at block 2002). Also, in some embodiments, the data triage operations (at block 2002) may be performed before, in parallel with, or after the model promotion operations (at block 2002). Furthermore, the method 2000 or portions thereof may be repeated (as individual operations or as a sequence of operations). For example, the data triaging operations (at block 2002) may be repeated one or more times (e.g., to create “continuous” learning) along with or separate from performance of the model promotion operations (at block 2004), which may also be repeated as models are promoted to different steps (e.g., “Prototype”, “Qualified,” and “Production”).

FIG. 2B is a flowchart representing the data triage operations performed at block 2002 of the method 2000. As noted above with respect to FIG. 2A, each block of the flowchart illustrated in FIG. 2B is illustrated once each and in a particular order; however, the operations may be reordered and/or repeated as desired and appropriate (e.g., different operations performed may be performed in parallel, as suitable).

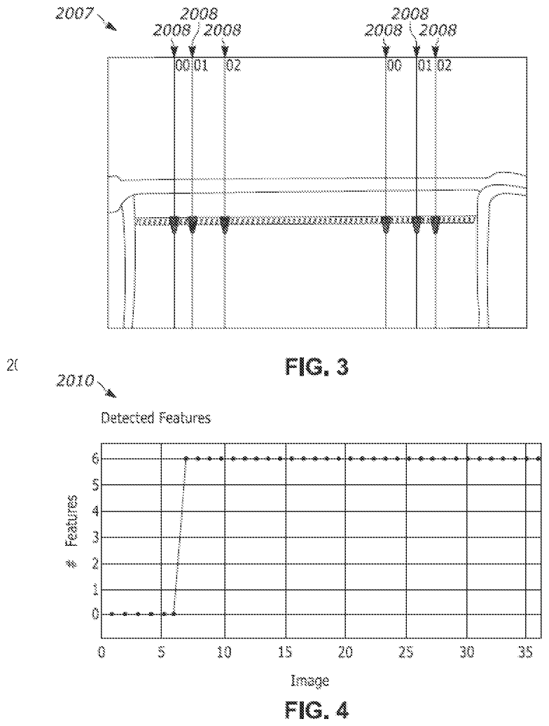

As illustrated in FIG. 2B, at block 2006, the feature identification logic 1006 uses a machine-learning model to generate one or more identified features in a set of images, such as a set of images generated via a CPM or other scientific instrument. FIG. 3 illustrates an example image 2007 included in a set of images generated via a scientific instrument and illustrates a plurality of features (referred to individually as “feature 2008” or “identified features 2008” and collectively as “features 2008” or “identified features 2008”) identified via a machine-learning model applied to the image 2007. As illustrated in FIG. 3, in this example, the identified features 2008 represent line indicated termination (LIT) features identified within the image 2007 and, in particular, represent six LIT features identified within the image 2007 via the machine-learning model. In some embodiments, the user interface logic 1012 is configured to generate one or more user interfaces displaying the image data set and the identified features. For example, in some embodiments, the user interface logic 1012 generates a user interface that allows a user to scroll (e.g., using a slider or similar selection mechanism, a gesture, a command, or the like) through a selected set of images and, for each displayed image of the set of images, one or more identified features are displayed within the image (e.g., as annotations as illustrated in FIG. 3). The user interfaces may also be configured to allow a user to select a particular set of images, select a particular feature identified in a set of images, or a combination thereof to view selected images and corresponding selected features.

Returning to FIG. 2B, at block 2009, the image selection logic 1008 determines if the identified features determined at block 2006 satisfy one or more selection criteria. In some embodiments, the image selection criteria are based on one or more metrics associated with an identified feature. The one or more metrics may be compared to one more predetermine thresholds representing expected metrics for identified features to detect an anomaly in the identified features, which may indicate that the machine-learning inferences were unsuccessful or otherwise should not be included in a training dataset used for additional training of the machine-learning model. In some embodiments, comparing a metric to an associated predetermined threshold includes comparing a metric to an expected value or range, determining a variance between a metric and an expected value (e.g., a threshold or reference) and comparing this variance to expected value or range, or a combination thereof.

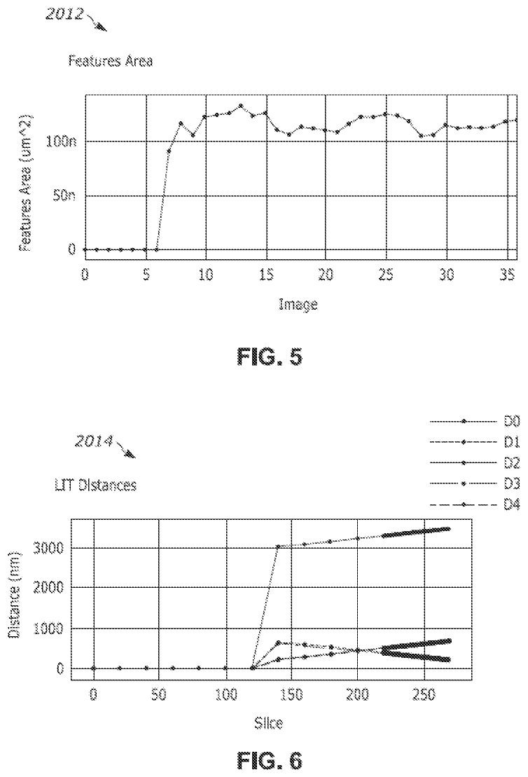

For example, one or more characteristics of the identified features in each image of a set of images may be plotted over the entire set of images, and a slope of this plot may be used as a metric for the identified features and, consequently, the set of images. In embodiments where the set of images is an LIT run and the identifier features are LIT features, the plotted characteristics may include a number of LIT features identified in each image, an area of the features identified in each image, or distances of the features identified in each image. For example, FIG. 4 is an example plot 2010 depicting a number of features identified per image in a set of images, FIG. 5 is an example plot 2012 depicting a feature area per image in a set of images, and FIG. 6 is an example plot 2014 depicting feature distances identified per image in a set of images. Using one of these example plots, the one or more metrics may include a slope average, a slope standard deviation, a location change, or a combination thereof. A location change is a metric for the number of features, such as the number of features identified for an LIT run.

For example, the following equations may be used to calculate slope average, slope standard deviation, and location change associated with a plot of the number of features identified in each image of the set of images (see, e.g., FIG. 4).

r=stats.linregress(x,y)

slope.append(r.slope)

runData[‘slope avg’]=np.mean(np.absolute(slope))

runData[‘slope std’]=np.std(np.absolute(slope))

runData[‘location change’]=np.sum(np.absolute(np.gradient(runData[‘features’]))).tolist( )

A value calculated from a plot as described above, may be compared to threshold (e.g., an expected value) to determine whether a set of images satisfies the one or more selection criteria. For example, under ideal conditions, the slope standard deviation for a plot of number of identified features for an LIT run should be zero (indicating that the same number of features was identified in each image of the set of images). Accordingly, a large slope standard deviation for such a plot may indicate that LIT features were not properly identified by the machine-learning model (i.e., the machine-learning inference was unsuccessful). As another example, if six LIT features were expected in each image (e.g., based on a known pattern on the sample), a location change metric associated with the number of identified features that is a value other than 6 indicates that LIT features were not identified correctly via the machine-learning model (i.e., the machine-learning inference was unsuccessful).

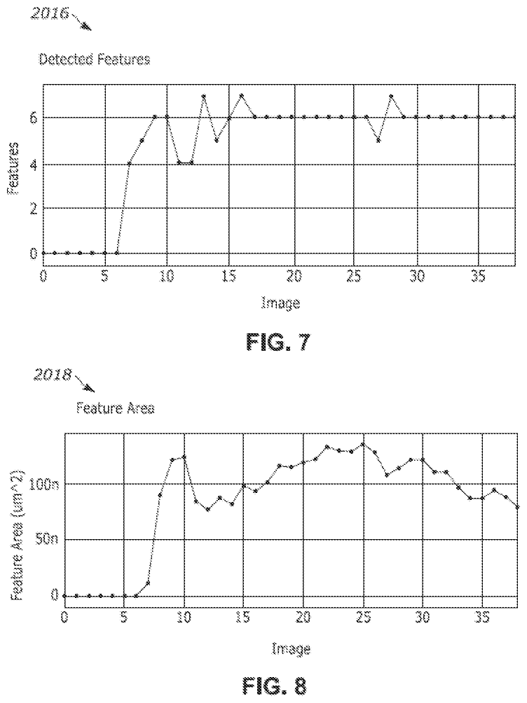

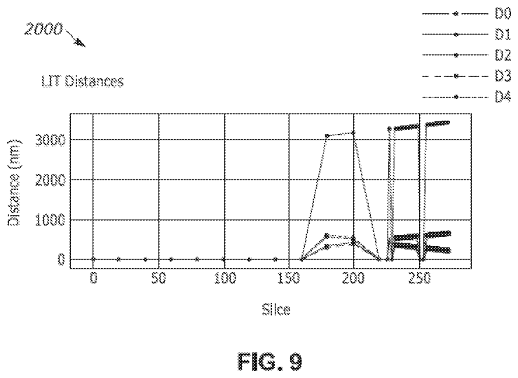

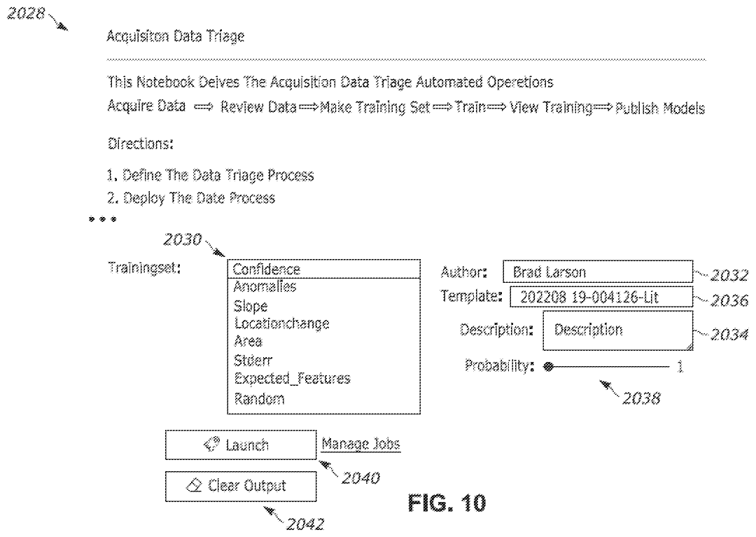

For example, plot 2016 illustrated in FIG. 7 depicts a plot of a number of features detected within a LIT run in which the number of identified features varies between 4 and 7. Similarly, plot 2018 illustrated in FIG. 8 depicts a plot of a feature area for features detected within a LIT run in which the feature area varies over images, wherein it is expected that the detected area would remain roughly constant when all LIT features are properly identified (e.g., with some variation as the LIT feature boundaries are obscured by the changing sample features). Plot 2020 illustrated in FIG. 9 similarly depicts a plot of a feature distance for features detected within an LIT run in which the feature distances are generally non-linear, wherein linear distances are expected for properly identified LIT features. Accordingly, each of the plots 2016, 2018, and 2020 represent unsuccessful machine-learning inferences that are not good candidate for use in additional training of the machine-learning model.

As noted above, the image selection logic 1008 may compare a determined metric to one or more thresholds to determine whether the set of images, including the associated inferences, should be automatically included in a particular training dataset for the machine-learning model (at block 2026) or automatically excluded from a training dataset (at block 2024). In some embodiments, the image selection logic 1008 may be configured to apply different selection criteria (e.g., thresholds) for different training datasets. For example, when the determined metric does not satisfy a threshold associated with a training dataset (e.g., the metric exceeds the threshold), the identified features may not represent inferences that, if feed back to the machine-learning model as training data, would improve the performance of the machine-learning model (e.g., the identified features do not accurately represent all of the LIT features that the model is supposed to identify). Accordingly, in this situation, when the metric fails to satisfy the threshold associated with the training dataset (at block 2022), the image selection logic 1008 may flag the image data set as being excluded from the training dataset for the machine-learning model (at block 2024). Alternatively, when the metric satisfies the threshold associated with a training dataset (at block 2022), the image selection logic 1008 may flag the set of images as being included in the training dataset (at block 2026). As noted above, the image selection logic 1008 may repeat this process (block 2022 and block 2024 or 2026) for each of the training datasets associated with training a model (e.g., the retraining dataset, the testing dataset, the validation dataset, the annotation dataset, or a subset thereof). Alternatively or in addition, the image selection logic 1008 may be configured to use one threshold for multiple training datasets. For example, in response to a metric failing to satisfy a threshold for the retraining dataset, the image selection logic 1008 may be configured to flag the set of images as being included in the annotation dataset for the machine-learning model, wherein a user may manually review, optionally annotate the set of images (e.g., mark features in the images not identified by the machine-learning model), and flag the set of images (as annotated) for inclusion in the retraining dataset.

In some embodiments, plots as described above may be provided via one or more user interfaces generated via the user interface logic 1012 and, in some embodiments, one or more plots may be displayed along with the corresponding images and identified features as described above with respect to block 2006. In some embodiments, the metrics determined by the image selection logic 1008 are also used to detect errors in image runs, such as an LIT run. For example, when a beam defocuses on the patterned wafer, features may not be correctly identified via the machine-learning model based on the quality of the images. Accordingly, based on the calculated set of metrics, the image selection logic 1008 may indicate an error and the output or record the error, such as, for example, within a user interface, which may alert a user that the run should be performed again.

As described above, the one or more selection criteria may include one or more thresholds (e.g., representing expected metric values or predetermined references) that the image selection logic 1008 compares to one or more metrics. In other words, the one or more selection criteria may use the metrics to identify an anomaly in a particular image or set of images, which may be used to automatically exclude the set of images from the retraining dataset or automatically include the set of images in the annotation dataset. For example, the one or more selection criteria may include a predetermined reference for a characteristic of the one or more identified features, wherein the image selection logic determines whether the set of images satisfies the one or more selection criteria by identifying an anomaly of the one or more identified features as compared to the predetermined reference. The predetermined reference for the characteristic of the one or more identified features may include at least one selected from a group consisting of a predetermined reference size of the one or more identified features, a predetermined reference number of the one or more identified features, a predetermined reference position of the one or more identified features, a predetermined reference shape of the one or more identified features, and a predetermined reference distance between two of the one or more identified features. The image selection logic may determine whether the set of images satisfies the one or more selection criteria by comparing the predetermined reference to the characteristic of the one or more identified features in a single image of the set of images or by comparing the predetermined reference to a representative characteristic of the one or more identified features in a plurality of images included in the set of images. The representative characteristic may include at least one selected from a group consisting of an average of the characteristic in the plurality of images, a mean of the characteristic in the plurality of images, a median of the characteristic in the plurality of images, a standard deviation of the characteristic in the plurality of images, and a slope of a plot of the characteristic in the plurality of images. In some embodiments, the predetermined reference is user-defined and may be set based on one or more inputs or indications received through one or more user interfaces.

Alternatively or in addition, the one or more selection criteria may compare metrics over multiple sets of images to identify patterns. For example, if a particular metric starts to vary over sets of images, the image selection logic 1008 may be configured to automatically exclude older sets of images and automatically include more recently generated sets of images in the retraining dataset or include one or more of the sets of images in the annotation dataset to allow the machine-learning model to be retrained for current conditions or operating parameters of the scientific instrument. Similarly, if metrics associated with a particular set of images differ by more than a predetermined amount from other sets of images generated by the scientific instrument, the selection criteria may dictate that the differing set of images be included in the annotation dataset (e.g., regardless of whether the metrics satisfy the threshold associated with the set of images). Accordingly, in some embodiments, the one or more selection criteria includes a characteristic of the one or more identified features and the image selection logic determines whether the set of images satisfies the one or more selection criteria by identifying a pattern of the characteristic over multiple sets of images, such as, for example, a change in the characteristic over the multiple sets of images or a change in the characteristic over the multiple sets of images exceeding a predetermined threshold, which may be a user-defined threshold. As noted above with respect to detecting anomalies, the characteristic of the one or more identified features used in identifying a pattern may include at least one selected from a group consisting of a size of the one or more identified features, a number of the one or more identified features, a position of the one or more identified features, a shape of the one or more identified features, and a distance between two of the one or more identified features.

Alternatively or in addition, the one or more selection criteria may include image quality parameters of an image or a set of images. For example, the one or more selection criteria may exclude a set of images from a training dataset in response to the set of images including a double image, an out-of-focus or blurred portion, or other image artifacts.

Alternatively or in addition, the one more selection criteria may include one or more random selection criteria. For example, the selection criteria may define that every 100^{th} generated set of images be included in the retraining dataset, the testing dataset, the validation dataset, the annotation dataset, or a combination thereof. In some embodiments, different datasets may have different random selection criteria, wherein, for example, every 100^{th} set of images is included in the annotation dataset and every 50^{th} set of images is included in the retraining dataset. Accordingly, in some embodiments, the one or more selection criteria includes a random selection, which may define a predetermined frequency for including the set of images in the training dataset. As for other selection criteria, the random selection may be user-defined.

Any of the above-described selection criteria may be established automatically (e.g., based on patterns or trends, such as based on multiple sets of images processed via a machine-learning model) or manually defined by a user, such as, for example, through one or more user interfaces generated via the user interface logic 1012. For example, the one or more selection criteria may include a user-defined rule that may be based on one or more characteristic of identified features as described above and various predetermined thresholds or references. For example, the image selection logic 1008 may be configured to receive a first indication of one or more first selection criteria (e.g., through one or more user interfaces), and determine whether a first set of images satisfies a first selection criteria, wherein the first set of images is included in at least one of the datasets in response to a determination that the first set of images satisfies the first selection criteria. The image selection logic 1008 may also be configured to receive a second indication of one or more second selection criteria, wherein the second selection criteria are different than the first selection criteria (e.g., through one or more user interfaces), and determine whether a second set of images satisfies the second selection criteria, wherein the second set of images is included in the at least one dataset in response to a determination that the second set of images satisfies the second selection criteria. In some embodiments, the user interfaces provided (e.g., via the user interface logic 1012) may include a list of available criteria for selection by a user. For example, FIG. 10 illustrates a user interface 2028 including a list 2030 of available selection criteria (e.g., a list of different types of selection criteria). As illustrated in FIG. 10, the list 2030 includes an “anomalies” selection criteria type that, when selected, allows a user to configure a rule for selecting an image or set of images to be included in a training dataset based on detected anomaly within an image or set of images as described above. Similarly, the “slope,” ‘locationchange,” “area,” “stderr,” and “expected features” selection criteria types allow a user to configure a rule for selecting an image or set of images based on one or more metrics or features detected within the image or set of images. Also, as illustrated in FIG. 10, the list 2030 includes a “confidence” selection criteria type that, when selected by a user, allows a user to establish a minimum confidence or probability level applied when a decision is made to add a particular image or set of images to a particular training data. For example, through the user interface 2028, a user may set a 75% confidence level, wherein an image or set of images is assigned to a particular training dataset if the decision by the support module 1000 is associated with a confidence level satisfying the user-established minimum confidence level.

In some embodiments, depending on the particular type of selection criteria selected by a user from the list 2030, the user interface 2028 provides one or more input or selection mechanisms for defining one or more details of the selected criteria. For example, as illustrated in FIG. 10, in response to receiving a selection of the “confidence” selection criteria from the list 2030, the user interface 2028 provides an author field 2032, a description field 2034, and a template field 2036. The author field 2032 allows a user to enter the name of an author of the “confidence” criteria or rule. In some embodiments, the author field 2032 may also be automatically populated by the support module 1000 based on log-in or other credentials of the user. The description field 2034 allows a user to add a description or comment about the rule, and the template field 2036 allows a user to specify or select a stored template representing a rule. For example, in some embodiments, selection criteria (e.g., configured through the user interface 2028, other user interfaces, in other manners) can be stored and reused.

After configuring any desired selection criteria through the user interface 2028, a user can select a “launch” selection mechanism 2040 to schedule the triaging workflow (e.g., evaluate acquired images according to the configured selection criteria) or at least access a next user interface or step of the configuration process for the triaging workflow. A user can select the “clear output” selection mechanism 2042 to clear inputs presented within the user interface 2028, such as, for example, details for a particular type of selection mechanism.

In some embodiments, the one or more selection criteria define sets of images to be included in each dataset. However, in other embodiments, the selection criteria may define sets of images to be included in a subset of the datasets. For example, in some embodiments, the one or more selection criteria defines sets of images to be included in the retraining dataset and the annotation dataset. The image selection logic 1008 may be configured to distribute images included in the retraining dataset to the testing dataset, the validation dataset, or both. This distribution may be performed randomly (e.g., accordingly to a predetermined division, 50% in training, 25% in testing, and 25% in validation) or based on metrics or parameters of the images included in the retraining dataset.

As noted above, images included in the annotation dataset are accessible through one or more user interfaces, where a user may review the images, manually include an image in a selected dataset, exclude an image from a selected dataset, add an annotation to an image (e.g., correcting an anomaly detected within features identified via the machine-learning model), or a combination thereof. For example, the feature identification logic 1006 may generate, via a machine-learning model, one or more first identified features in a first set of images acquired via a scientific instrument and generate, via the machine-learning model, one or more second identified features in a second set of images acquired via the scientific instrument. The image selection logic 1008 (through the user interface logic 1012) may provide the first set of images and the one or more first identified features to a user interface, and provide the second set of images and the one or more second identified features to the user interface, wherein the first set of images is excluded from a training set for the machine-learning model in response to a first indication, by a user, through the user interface, and the second set of images in included in the training set for the machine-learning model in response to a second indication, by the user, through the user interface. The user interfaces may provide one or more input mechanisms, selection mechanisms, or a combination thereof that allow a user to manually assign a particular image or set of images to a particular training dataset. The input or selection mechanisms may include a drop-down menu where a user can select a “assign to . . . ” menu option, a button designated for a particular training dataset that a user can select to manually assign an image or set of images to the designated training data, a drop-and-drag feature wherein a user can move an image or set of images within the user interface to manually assign the image or set of images to a particular training dataset, or the like

Accordingly, under control of the automated machine-learning workflow of the support module 1000, a user has access to a prepared list of images (e.g., LIT runs) to review along with corresponding sets of candidate annotations (i.e., inferences generated via the machine-learning model). Thus, rather than being tasked with reviewing all inferences, the workflow described above, creates a limited set of images (and corresponding inferences) for a user to manually review. As noted above, creating such a limited list is advantageous relative to conventional manual approaches in which the user is presented with a seemingly endless list of images that must be waded through to identify anomalies or inferences that should be manually corrected or rely solely on sporadic manual checking of inferences, which creates a high likelihood of missing many relevant inference errors that, once corrected, create valuable training data for the machine-learning model. In some embodiments, a user may allocate an image initially included in the annotation dataset to a specific different dataset (e.g., the retraining dataset, the testing dataset, or the validation dataset). In other embodiments, the user may indicate that an image should be included in a training dataset (e.g., without specifying a particular training dataset) and the image selection logic 1008 may be configured automatically allocate the included image in an appropriate dataset. Also, a user may flag a particular image as not be included in any training dataset used for training the machine-learning model.

In some embodiments, the image selection logic 1008 generates and transmits at least one alert regarding an image and the associated one or more identified features being available through one or more user interfaces. The alert may be transmitted via at least one selected from a group consisting of an email, a text message, and a software notification.

Returning to FIG. 2B, at block 2040, the training logic 1010 retrains the machine-learning model using the sets of images and associated identified features (machine-learning inferences) included in one or more of the available datasets (e.g., the retraining dataset, the testing dataset, and the validation dataset). For example, in some embodiments, the training logic 1010 retrains the machine-learning model using the retraining dataset and tests and validates the machine-learning model (as retrained) using the testing dataset and the validation dataset, respectively.

In some embodiments, the training logic 1010 retrains the machine-learning model in response to a triggering event. The triggering event may be based on a number of user-annotated images included in the training set, an increase in a size of the training set, an increase in a number of user-annotated images (e.g., overall or for a predetermined feature), an availability of one or more training resources, or a manual initiation by the user (e.g., received through a user interface generated via the user interface logic 1012). Accordingly, as sets of images are generated via the scientific instrument and one or more identified features are generated via the machine-learning model as described above, the sets of images (including the identified features) are automatically processed as described above to identify what training datasets images (including the associated identified features) should be included in or excluded from, and, in response to the occurrence of a triggering event, the training logic 1010 uses the generated training datasets to retrain the machine-learning model.

The training logic 1010 may perform the training of the machine-learning model in accordance with a training configuration. The training configuration may include one or more training features such as, but not limited to, a determination of which models to train, an initial transfer of learning models to a training set, the training resources to use (e.g., hardware choice, amount of parallelism, batch size, return on investment, available graphical processing units, nodes), training stop conditions (e.g., a threshold number of training epochs, a rate of convergence, a lack of convergence), or a combination thereof.

In some embodiments, retraining a machine-learning model may consume a significant amount of computing resources. To address this issue, in some embodiments, the training logic 1010 defines a training job within an workflow engine configured to manage parallel jobs, such as, for example, an Argo workflow on Kubernetes, which allows training (and, optionally, promotion as described below) to be performed reliably even if computing resources are scarce by acquiring resources for a training job at the time they are needed and freed when a task is complete.

During retraining, training losses of the machine-learning model may be stored and compared, which, as described in more detail below, may be used to determine model performance and promote a model as appropriate.

The data triaging operations illustrated in FIG. 2B may be repeated to create a “continuous” learning workflow for the machine-learning model. This “continuous” learning workflow establishes ongoing monitoring and improvement of the machine-learning model, which enables not only model qualification but also allows performance of the model to improve through repeat training using customer-specific data. Improving performance of the machine-learning model leads to further improvements in scientific instrument operation and associated processes, such as, for example, more accurate sample preparation accuracy and image quality.

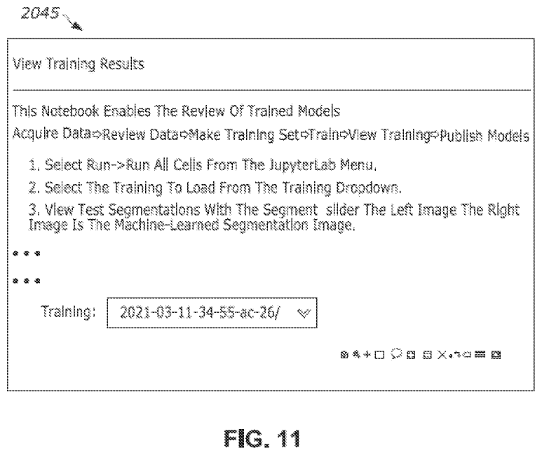

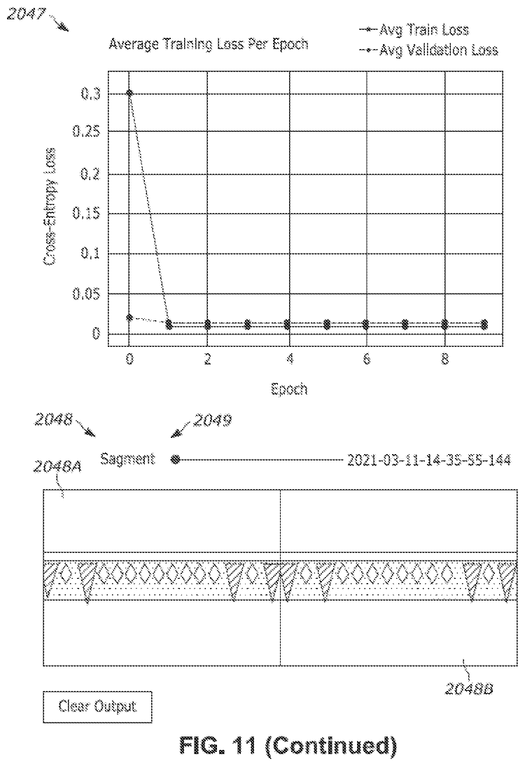

As described above, the user interface logic 1012 may be configured to provide one or more user interfaces associated with the automated data triaging process. All or some of the user interface generated as part of performing the data triage operations may include similar features, components, and functionality as described below with respect to the graphical user interface 3000. For example, in addition to providing user interfaces that allow a user to provide include and exclude feedback on images automatically included in a particular training dataset, and optionally, annotations, the user interface logic 1012 may provide one or more user interfaces that allow a user to review images and associated inferences, set and modify the one or more selection criteria used by the image selection logic 1008, request that data triaging be re-run (e.g., after modifying the one or more selection criteria), set or modify a training configuration applied by the training logic 1010, or a combination thereof. Through the user interfaces, a user may also control an amount of automated applied via the support module 1000 during the data triaging. For example, in some embodiments, a user may configure the support module 1000 to perform the data triaging in a completely automated fashion (e.g., without prompting a user to review images included in the annotation dataset). Model training results may also be presented through one or more user interfaces. FIG. 11 illustrates an example user interface 2045 providing training information. As illustrated in FIG. 11, the user interface 2045 may provide a plot 2047 depicting an average training loss per epoch and an average validation loss per epoch. The user interface 2045 may also provide test segments 2048, wherein a left image 2048a in a test segment 2048 represents a ground truth image and a right image 2048b in a test segment 2048 represents an associated inference generated via the machine-learning model. The user interface 2045 may also include a slider or other selection mechanism 2049 that allows a user to scroll through test segments. Also, in some embodiments, the user interface 2045 includes one or more selection mechanisms that enable a user to select a specific training from a list of model trainings.

Returning to FIG. 2B, in addition to performing the data triage operations (at block 2002) as described above, the support module 1000 may also be configured to perform the model promotion operations (at block 2004, such as, for example, via the model promotion logic 1004). Again, as recognized above, in some embodiments, the support module 1000 may be configured to perform just the data triage operations (at block 2002) or just the model promotion operations (at block 2004), and, in some embodiments, the support module 1000 is configured to perform the data triage operations (at block 2002), the model promotion operations (at block 2004), or a combination thereof in a repeated fashion or in various orders or arrangements, including performance in parallel, serially, or a combination thereof.

As described in more detail below, the model promotion logic 1004 is configured to automatically score, select, and deploy machine-learning models. Other approaches to deploy machine-learning models typically rely on experts in machine-learning operations, wherein customer data is provided to the experts for use in generating and deploying a machine-learning model. These experts execute, view, and evaluate various steps in a machine-learning workflow to test and deploy the machine-learning model to one or more customers, wherein such models are often frozen for months or years and rely on the experts to manage improvement or retraining of the models. As discussed above, images created by scientific instruments are often considered sensitive and proprietary, and, thus, such users are often unwilling to share such images. Accordingly, the automatic deployment of models performed by the model promotion logic 1004 improves microscopy technology by receiving the benefits of training machine-learning algorithms on user data (including, for example, improved accuracy, robustness, and execution speed) without requiring the disclosure of sensitive and proprietary data to an expert. In contrast, the model promotion logic 1004 may be deployed on a customer's computing environment without requiring intervention and management by machine-learning experts. Accordingly, the model promotion logic 1004 enables changes (i.e., retrained models or models outperforming other available models) to be efficiently pushed out to a fleet of scientific instruments (e.g., CPMs) based on customer-specific improvements. For example, the model promotion logic may be configured to test models and compare models to identify a model that best achieves an objective, wherein this “best” model may then be deployed (e.g., with or without human oversight).

FIG. 2C is a flowchart representing the model promotion operations performed at block 2004 of the method 2000 in accordance with some embodiments (e.g., via the model performance logic 1014, user interface logic 1016, promotion logic 1018, or a combination thereof). As noted above with respect to FIG. 2A, each block of the flowchart illustrated in FIG. 2C is illustrated once each and in a particular order; however, the operations may be reordered and/or repeated as desired and appropriate (e.g., different operations performed may be performed in parallel, as suitable). For example, in some embodiments, the model promotion operations (at block 2004) may be performed accordingly to a predetermined schedule or frequency (e.g., once a week, once a month), in response to a triggering condition (e.g., after a machine-learning model is retrained or has been deployed for a predetermined amount of time or applied to predetermined number of images), in response to a manual initiation, or a combination thereof.

As illustrated in FIG. 2C, at block 2500, the model performance logic 1014 generates one or more performance measurements for each of a one or more machine-learning models, such as, for example, each of a plurality of machine-learning models associated with a particular customer, a set of scientific instruments, or the like.

The model performance logic 1014 may consider various parameters of a machine-learning model to generate a performance metric. For example, as noted above, training losses may be stored by the training logic 1010 as part of retraining a machine-learning model, and, in some embodiments, the model performance logic 1014 uses these losses to generate a performance metric for a model.

Alternatively or in addition, the performance metrics may be based on offline tests performed by the model performance logic 1014 to score the performance of a machine-learning model. In some embodiments, a lower score indicates better model performance. In other embodiments, a higher score indicates better model performance. Performance metrics may include segmentation accuracy and similarity, inference time, confusion, or one or more process-specific metrics. The process-specific metrics may be based on expected characteristics of an inference for a specific sample, such as a percent mode error, percent feature error, average slope, slope standard deviation, average standard error, or a combination thereof. Process-specific metrics be generated using separate datasets. The offline tests may be customized for a specific machine-learning model and may include one or more sub-tests. The test results may be combined into a single score for comparing and promoting models.

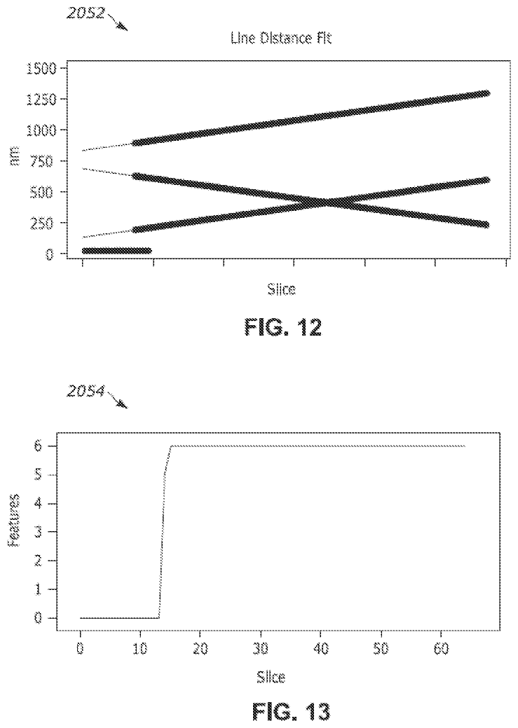

For example, the model performance logic 1014 may implement a LIT test that includes two test metrics, including, for example, “linearity standard error” for indicating accuracy and “feature change” for indicating robustness. By way of example, FIG. 12 depicts a plot 2052 indicative of a linearity standard error metric, and FIG. 13 depicts a plot 2054 indicative of a feature change metric. The model performance logic 1014 may evaluate candidate models over a stored testing dataset and may combine the test results in a suitable manner (e.g., as a weighted sum).

In some embodiments, the model performance logic 1014 may apply a common testing dataset across a plurality of models to compare performance between each of the plurality of models. In some embodiments, updating such a common testing dataset may trigger performance of the model promotion operations (at block 2004) as described herein.

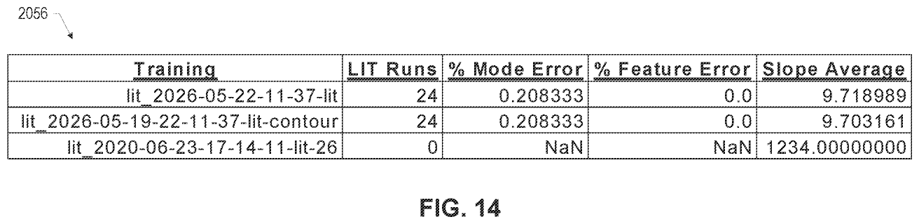

In some embodiments, a set of test results for a model may be provided to the user via the graphical user interface 3000. Each set of test results may include graphical depictions of a model's performance metrics. For example, the model performance logic 1014 may (through the user interface logic 1016) provide plots, tables, identified features, or other graphical depictions of a model's performance metrics. FIG. 14 depicts a graph 2056 of performance metrics for a plurality of machine-learning models, which may be presented to a user in one or more user interfaces.

Returning to FIG. 2C, at block 2070, the promotion logic 1018 determines whether the one or more performance metrics for a model satisfy promotion criteria. The promotion criteria may be based on a comparison of performance metrics for different models, and, in some embodiments, different performance metrics may be weighted differently (e.g., based on a level of importance of the test used to generate the performance metric). The promotion logic 1018 may be configured to apply a default comparison algorithm but may enable a user to override this algorithm or portions thereof. The default comparison algorithm may assign each performance metric to one or more categories (e.g., error, validity, etc.), normalize and scale each performance metric so that a larger value indicates a greater importance, sum the performance metrics in each category to create a score for the category, and create a weighted sum from the sums of each category (i.e., to create a composite model score). In some embodiments, each category defines limits to exclude infeasible results, and the composite model score may represent a weighted sum of feasible results from each category. Similarly, in some embodiments, the composite model score may be used to classify all models as either feasible or infeasible. The composite model score for all feasible models may then be compared to identify a “best” or highest performing model. In some embodiments, one or more thresholds may also be applied to the composite model scores to determine whether a model satisfies promotion criteria.

In response to the performance metrics of a machine-learning model satisfying promotion criteria, the promotion logic 1018 may automatically promote the model. As an alternative to automatically promoting a model, one or more user interfaces or alerts may be generated to inform a user when a model satisfies promotion criteria and prompt the user to confirm the promotion. In some embodiments, the support module 1000 enables a user to configure a level of automatic or manual promotion and, in some embodiments, the promotion logic 1018 may apply a combination of automatic and manual promotion. For example, in some embodiments, the promotion logic 1018 may be configured to compare a highest composite model score among a plurality of models to a threshold and if the score satisfies the threshold, the promotion logic 1018 may promote the model. However, in response to the highest composite score not satisfying the threshold, the promotion logic 1018 (e.g., through the user interface logic 1016) may prompt a user to confirm whether any of the models should be promoted. In some embodiments, the promotion logic 1018 also applies other conditions when determining whether to promote a model, such as, for example, conditions under which a model was trained, such as what features the model identifies, what type or size of images the model was trained with, or the like.

Promoting a model may include deploying the model for use by a scientific instrument in performing feature identification in generated images (at block 2080). In other embodiments, however, the promotion logic 1018 may be configured to promote a model through a plurality of steps or states, such as, for example, “Prototype,” “Qualified,” and “Production.” When using a plurality of steps, the promotion logic 1018 may be configured to, for each step, generate loss, test, and deploy scores, which may be weighted to identify qualifying models (e.g., using step-specific promotion criteria).

In some embodiments, the promotion logic 1018 may manage model promotion using a finite state machine (“FSM”) in which step-transitions are based on a set of transition rules. For example, the FSM may include a “Candidate” state corresponding to all trained models that have not transitioned to other steps. In some embodiments, the “Candidate” state corresponds to all models which were determined to be feasible. The FSM may then transition to a “Qualified” state corresponding to models that satisfy customizable rules such as, for example, training set size, a specific customer sample type, number of valid runs across multiple tools by specific process engineers, validity score beyond a configurable threshold, and/or error score beneath a threshold. To transition from the “Qualified” state to the “Production” state, rules, such as, for example, a larger number of runs, one or more test thresholds, approval by process engineers, or other criteria may be satisfied. For example, in some embodiments, a user may qualify new models to the “Production” state during a day shift where greater process support is available but may limit a night shift to either a fixed model or to the highest scoring model in the “Production” state. In some embodiments, a user may, via the graphical user interface 3000, define levels (e.g., hours of operation, test results), manual approval, qualification per customer fab processes, etc. for promoting a model between any of the available steps or states, including a “Production” or deployed state.

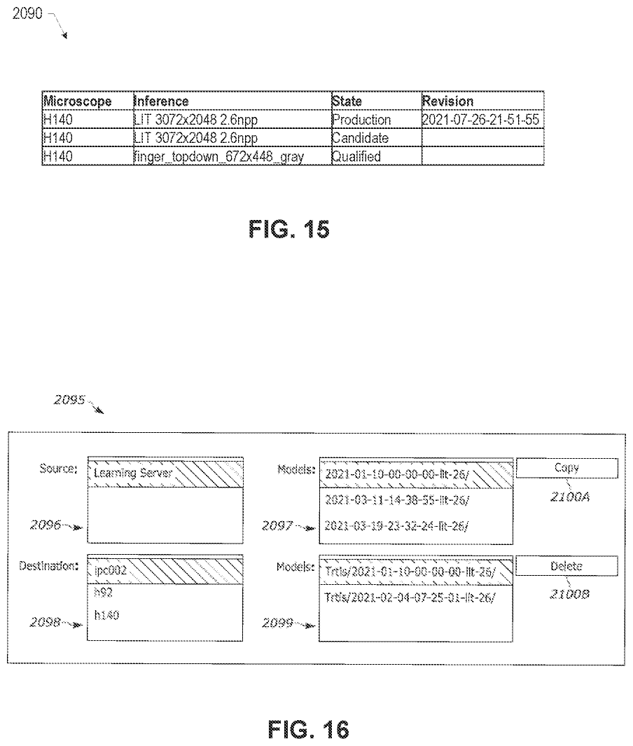

In some embodiments, to deploy a model to a scientific instrument, communication is established between the scientific instrument and a machine-learning server (storing the model) via a suitable element included in the scientific instrument support system 5000. In some embodiments, a scientific instrument cluster network may be deployed to establish communication when one or more elements of the scientific instrument support system 5000 are not included in a users communication network. Once communication is established, the machine-learning server may identify and establish a bi-directional communication with an inference computer associated with the scientific instrument (i.e., the computer configured to apply a machine-learning model to a set of images) by creating a directory of inference computers and downloading communications addresses credentials to each inference computer. To receive a new model or models, a scientific instrument may register, with the machine-learning server, one or more model deployment criteria. The model deployment criteria may include, for example, the specific inference, model state, and/or specific model instance it would like to receive. FIG. 15 depicts example model deployment criteria 2090 associated with a particular scientific instrument for registering with the machine-learning server.

After registering, the machine-learning server provides the model or models meeting the one or more model deployment criteria to the registered scientific instrument. In some embodiments, when a new model is promoted and meets the one or more model deployment criteria, the model is automatically downloaded from the machine-learning server to the scientific instrument and loaded into the inference computer. Once loaded, the next inference call associated with the scientific instrument may use the newly downloaded model.

As noted above, in some embodiments, the support module 1000 enables a user to manually control deployment of a model. For example, FIG. 16 illustrates a portion of a user interface 2095 that displays a list of selectable model sources 2096 and a list of selectable models 2097 available in the model source selected in the list of selectable model sources 2096. The user interface 2095 also includes a list of selectable scientific instruments 2098 and a list of models 2099 representing the models deployed to the scientific instrument selected within the list of selectable scientific instruments 2098. The user interface 2095 further includes a copy selection mechanism 2100A and a delete selection mechanism 2100B. In response to receiving a selection of the copy selection mechanism 2100A, a model selected in the list of selectable models 2097 is deployed to the instrument selected in the list of selectable scientific instruments 2098. In response to receiving a selection of the delete selection mechanism 2100B, a model selected in the list of models 2099 is removed from (i.e., no longer deployed or use by) the scientific instrument selected in the list of selectable scientific instruments 2098.

As noted above, the scientific instrument support methods disclosed herein may include interactions with a human user (e.g., via the user local computing device 5020 discussed herein with reference to FIG. 19). These interactions may include providing information to the user (e.g., information regarding the operation of a scientific instrument such as the scientific instrument 5010 of FIG. 19, such as, for example, inferences generated via one or more machine-learning models for sets of images generated via the scientific instrument; information regarding a sample being analyzed or other test or measurement performed by a scientific instrument; information retrieved from a local or remote database or other data storage device or arrangement, or other information) or providing an option for a user to input commands (e.g., to control the operation of a scientific instrument such as the scientific instrument 5010 of FIG. 19, or to control the analysis of data generated by a scientific instrument), queries (e.g., to a local or remote database or other data storage device or arrangement), or other information. In some embodiments, these interactions may be performed through a graphical user interface (GUI) that includes a visual display on a display device (e.g., the display device 4010 discussed herein with reference to FIG. 18) that provides outputs to the user and/or prompts the user to provide inputs (e.g., via one or more input devices, such as a keyboard, mouse, trackpad, or touchscreen, included in the other I/O devices 4012 discussed herein with reference to FIG. 18). The scientific instrument support systems disclosed herein may include any suitable GUIs for interaction with a user.

FIG. 17 depicts an example graphical user interface 3000 that may be used in the performance of some or all of the support methods disclosed herein, in accordance with various embodiments. As noted above, the graphical user interface 3000 may be provided on a display device (e.g., the display device 4010 discussed herein with reference to FIG. 18) of a computing device (e.g., the computing device 4000 discussed herein with reference to FIG. 18) of a scientific instrument support system (e.g., the scientific instrument support system 5000 discussed herein with reference to FIG. 19), and a user may interact with the graphical user interface 3000 using any suitable input device (e.g., any of the input devices included in the other I/O devices 4012 discussed herein with reference to FIG. 18) and input technique (e.g., movement of a cursor, motion capture, facial recognition, gesture detection, voice recognition, actuation of buttons, etc.).

The graphical user interface 3000 may include a data display region 3002, a data analysis region 3004, a scientific instrument control region 3006, and a settings region 3008. The particular number and arrangement of regions depicted in FIG. 17 is simply illustrative, and any number and arrangement of regions, including any desired features, may be included in a graphical user interface 3000.

The data display region 3002 may display data generated by a scientific instrument (e.g., the scientific instrument 5010 discussed herein with reference to FIG. 19). For example, the data display region 3002 may display any appropriate data generated during performance of the data triage operations (at block 2002), the model promotion operations (at block 2004), or a combination thereof as described above, such as, for example, images generated via the scientific instruments, identified features (i.e., inferences) generated by a machine-learning model applied to the images, or the like.

The data analysis region 3004 may display the results of data analysis (e.g., the results of analyzing the data illustrated in the data display region 3002 and/or other data). For example, the data analysis region 3004 may display any appropriate data generated during performance of the data triage operations (at block 2002), the model promotion operations (at block 2004), or a combination thereof as described above, such as, for example, inference metrics and plots depicting the same, training results, performance metrics, or the like. In some embodiments, the data display region 3002 and the data analysis region 3004 may be combined in the graphical user interface 3000 (e.g., to include data output from a scientific instrument, and some analysis of the data, in a common graph or region).

The scientific instrument control region 3006 may include options that allow the user to control a scientific instrument (e.g., the scientific instrument 5010 discussed herein with reference to FIG. 19). For example, the scientific instrument control region 3006 may include any appropriate ones of the options or control features provided during performance of the data triage operations (at block 2002), the model promotion operations (at block 2004), or a combination thereof as described above, such as, for example, options for setting and modifying selection criteria for images, options for manually including or excluding images, options for annotating an image, options for setting or modifying a training configuration, options for setting and modifying promotion criteria, options for manually deploying a model, or the like.

The settings region 3008 may include options that allow the user to control the features and functions of the graphical user interface 3000 (and/or other GUIs) and/or perform common computing operations with respect to the data display region 3002 and data analysis region 3004 (e.g., saving data on a storage device, such as the storage device 4004 discussed herein with reference to FIG. 18, sending data to another user, labeling data, etc.). For example, the settings region 3008 may include any appropriate ones of the settings associated with performance of the data triage operations (at block 2002), the model promotion operations (at block 2004), or a combination thereof as described above, such as, for example, annotating images, manually including or excluding images, registering with a machine-learning server, communicating model deployment criteria communication, or the like.

As noted above, the support module 1000 may be implemented by one or more computing devices. FIG. 18 is a block diagram of a computing device 4000 that may perform some or all of the scientific instrument support methods disclosed herein, in accordance with various embodiments. In some embodiments, the CPM support module 1000 may be implemented by a single computing device 4000 or by multiple computing devices 4000. Further, as discussed below, a computing device 4000 (or multiple computing devices 4000) that implements the CPM support module 1000 may be part of one or more of the scientific instrument 5010, the user local computing device 5020, the service local computing device 5030, or the remote computing device 5040 of FIG. 19.

The computing device 4000 of FIG. 18 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 18, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the CPM support logic or methods disclosed herein may be part of a scientific instrument support system. FIG. 19 is a block diagram of an example scientific instrument support system 5000 in which some or all of the scientific instrument support methods disclosed herein may be performed, in accordance with various embodiments. The CPM support apparatus and methods disclosed herein (e.g., the CPM support module 1000 of FIGS. 1A, 1B, ad 10 and the method 2000 of FIGS. 2A, 2B, and 2C) may be implemented by one or more of the scientific instrument 5010, the user local computing device 5020, the service local computing device 5030, or the remote computing device 5040 of the scientific instrument support system 5000.

Any of the scientific instrument 5010, the user local computing device 5020, the service local computing device 5030, or the remote computing device 5040 may include any of the embodiments of the computing device 4000 discussed herein with reference to FIG. 18, and any of the scientific instrument 5010, the user local computing device 5020, the service local computing device 5030, or the remote computing device 5040 may take the form of any appropriate ones of the embodiments of the computing device 4000 discussed herein with reference to FIG. 18.

The scientific instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 18, and the processing devices 5002 included in different ones of the scientific instrument 5010, the user local computing device 5020, the service local computing device 5030, or the remote computing device 5040 may take the same form or different forms. The storage device 5004 may take any suitable form, including the form of any of the storage devices 4004 discussed herein with reference to FIG. 18, and the storage devices 5004 included in different ones of the scientific instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 18, and the interface devices 5006 included in different ones of the scientific instrument 5010, the user local computing device 5020, the service local computing device 5030, or the remote computing device 5040 may take the same form or different forms.

The scientific instrument 5010, the user local computing device 5020, the service local computing device 5030, and the remote computing device 5040 may be in communication with other elements of the scientific instrument support system 5000 via communication pathways 5008. The communication pathways 5008 may communicatively couple the interface devices 5006 of different ones of the elements of the scientific instrument support system 5000, as shown, and may be wired or wireless communication pathways (e.g., in accordance with any of the communication techniques discussed herein with reference to the interface devices 4006 of the computing device 4000 of FIG. 18). The particular scientific instrument support system 5000 depicted in FIG. 19 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the scientific instrument 5010, but may instead communicate with the scientific instrument 5010 via the communication pathway 5008 between the service local computing device 5030 and the user local computing device 5020 and the communication pathway 5008 between the user local computing device 5020 and the scientific instrument 5010.

In some embodiments, the scientific instrument 5010 includes any appropriate CPM, such as a scanning electron microscope (SEM), a transmission electron microscope (TEM), a scanning transmission electron microscope (STEM), or an ion beam microscope (and may include other scientific instruments). For example, FIG. 20 illustrates the scientific instrument 5010 implemented as a CPM 6000 according to some embodiments. The CPM 6000 illustrated in FIG. 20 represents a scanning electron microscopy with energy dispersive X-ray spectroscopy (SEM/EDX) system. However, as previously noted, the CPM 6000 illustrated in FIG. 20 is provided as one example type of CPM and the support methods described herein may be used with other types of CPMs or even other types of scientific instruments. As illustrated in FIG. 20, the CPM 6000 includes a particle-optical column 6015 mounted on a vacuum chamber 6006. Within the particle-optical column 6015, electrons generated by electron source 6012 are modified by a compound lens system 6014 before being focused onto sample 6002, as an incident beam 6004, by lens system 6016. The incident beam 6004 may be scanned over the sample 6002 by operating scan coils 6013. The sample may be held by sample stage 6008. The CPM 6000 may include multiple detectors for detecting various emissions from sample 6002 in response to the irradiation of incident beam 6004. A first detector 6003 may detect the X-rays emitted from the sample 6002. In one example, detector 6003 may be a multi-channel photon-counting EDX detector. A second detector 6001 may detect electrons, such as the backscattered and/or secondary electrons emitted from sample 6002. In one example, detector 6001 may be a segmented electron detector. As illustrated in FIG. 9, the CPM 6000 also includes a computing device 4000 as generally described above with respect to FIG. 18. The computing device 4000 may be configured to send and receive one or more control signals as described below and, in some embodiments, may perform the support methods described herein. For example, the computing device 4000 may be configured to perform the data triage operations (at block 2002), the model promotion operations (at block 2004), or combinations or subsets thereof. For example, in some embodiments, the computing device 4000 may be configured to generate a set of images and the one or more identified features and, hence, may be referred to as an “inference” computer or computing device. The set of images and the associated one or more identified features may be further processed by the computing device 4000 of the CPM 6000 as described above. However, as noted above, in some embodiments, the set of images and the associated one or more identified features may be transmitted to one or more computing devices remote from the CPM 6000, such as to a server collecting sets of images and inferences associated with a plurality of instruments and implementing the image selection logic 1008, the training logic 1010, the user interface logic 1012, or combinations or subsets thereof (as well as, optionally, the model performance logic 1014, the promotion logic 1018, the user interface logic 1016, or combinations or subsets thereof). Also, in some embodiments, the generation of the set of images, the one or more identified features, or both may be performed at one or more computing devices remote from the CPM 6000. Accordingly, the inclusion of the computing device 4000 in the CPM 6000 illustrated in FIG. 20 represents one possible embodiment of such a scientific instrument.

Returning to FIG. 19, the user local computing device 5020 may be a computing device (e.g., in accordance with any of the embodiments of the computing device 4000 discussed herein) that is local to a user of the scientific instrument 5010. In some embodiments, the user local computing device 5020 may also be local to the scientific instrument 5010, but this need not be the case; for example, a user local computing device 5020 that is in a users home or office may be remote from, but in communication with, the scientific instrument 5010 so that the user may use the user local computing device 5020 to control and/or access data from the scientific instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the scientific instrument 5010. For example, the service local computing device 5030 may be local to a manufacturer of the scientific instrument 5010 or to a third-party service company. In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 may utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 may be a computing device (e.g., in accordance with any of the embodiments of the computing device 4000 discussed herein) that is remote from the scientific instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010. In some embodiments, the data triage logic 1002, the model promotion logic 1004, or combinations of subsets thereof is implemented on the remote computing device 5040. For example, as noted above, in some embodiments, the remote computing device 5040 receives data from one or more scientific instruments 5010, such as, for example, a set of images and associated inferences generated via a machine-learning model and the remote computing device 5040 implements the image selection logic 1008, the training logic 1010, the user interface logic 1012, or combinations or subsets thereof (as well as, optionally, the model performance logic 1014, the promotion logic 1018, the user interface logic 1016, or combinations or subsets thereof). Again, the functionality described herein as being performed via the support apparatus can be performed by one device or distributed across a plurality of devices in various configurations.

In some embodiments, one or more of the elements of the scientific instrument support system 5000 illustrated in FIG. 19 may not be present. Further, in some embodiments, multiple ones of various ones of the elements of the scientific instrument support system 5000 of FIG. 19 may be present. For example, a scientific instrument support system 5000 may include multiple user local computing devices 5020 (e.g., different user local computing devices 5020 associated with different users or in different locations). In another example, a scientific instrument support system 5000 may include multiple scientific instruments 5010, all in communication with service local computing device 5030 and/or a remote computing device 5040; in such an embodiment, the service local computing device 5030 may monitor these multiple scientific instruments 5010, and the service local computing device 5030 may cause updates or other information may be “broadcast” to multiple scientific instruments 5010 at the same time. Different ones of the scientific instruments 5010 in a scientific instrument support system 5000 may be located close to one another (e.g., in the same room) or farther from one another (e.g., on different floors of a building, in different buildings, in different cities, etc.). In some embodiments, a scientific instrument 5010 may be connected to an Internet-of-Things (IoT) stack that allows for command and control of the scientific instrument 5010 through a web-based application, a virtual or augmented reality application, a mobile application, and/or a desktop application. Any of these applications may be accessed by a user operating the user local computing device 5020 in communication with the scientific instrument 5010 by the intervening remote computing device 5040. In some embodiments, a scientific instrument 5010 may be sold by the manufacturer along with one or more associated user local computing devices 5020 as part of a local scientific instrument computing unit 5012.

In some embodiments, different ones of the scientific instruments 5010 included in a scientific instrument support system 5000 may be different types of scientific instruments 5010. In some such embodiments, the remote computing device 5040 and/or the user local computing device 5020 may combine data from different types of scientific instruments 5010 included in a scientific instrument support system 5000.

Accordingly, embodiments described herein provide a continuous learning workflow for a machine-learning model. This workflow generally includes performing automated data triage to automatically select useful images for training, testing, validating, and human review and annotation, wherein the datasets generated based on this automated data triage are used to train (i.e., retrain) a machine-learning model. After this training (and associated testing), the machine-learning model is used to generate future inferences, which are used for control and operation of scientific instruments and associated processes, such as, for example, sample preparation. Accordingly, as the machine-learning model is improved through this continuous learning workflow and adapts to changing processes, the resulting control and operation of the scientific instruments and associated processes also improves. In some embodiments, this learning workflow uses data available at a customers site and effectively moves the learning workflow to the customer, while minimizing human effort and required expertise in machine learning. In other words, the automated data triaging optimizes human interaction in the learning workflow in an automated feedback loop.

As also described above, some embodiments provide automated model promotion (e.g., as part of a workflow including automated data triaging or separate from automated data triaging). Model promotion may be based on training losses or process specific algorithms that may consider one or more performance metrics of a machine-learning model (e.g., generated based on one or more offline tests) and optionally compare such performance metrics across available models to identify a best performing or optimal model. In some embodiments, multiple steps or stages of promotion may be used to classify different available models, wherein a model promotion integrates a machine-learning model into a laboratory process (e.g., a test process, a production process, etc.). By configuring promotion criteria, a customer controls a level of automated model promotion to best suit their confidence and needs and without requiring expertise in machine learning. Accordingly, the automated model promotion process identifies optimized models and, through a customized level of human intervention, deploys models to scientific instruments in a reliable and observer able manner (e.g., where deployed models are tracked to define where, when, and what models are being executed.

As also noted above, although embodiments were described herein with respect to one or more particular scientific instruments (e.g., a CPM) and particular machine-learning inferences (e.g., LIT runs), the methods and systems described herein are not limited in application to any particular scientific instrument or any particular machine-learning inferences. Rather, the methods and systems described herein may be used to provide a learning workflow and optional model promotion workflow for machine-learning models used by various types of scientific instruments and generate various types of inferences.

According to an example embodiment disclosed above, e.g., in reference to any one or any combination of some or all of FIGS. 1-20, provided is an apparatus comprising: feature identification logic to generate, using a machine learning model, or more identified features in an image of a set of images acquired via a scientific instrument; image selection logic to determine whether the set of images satisfies one or more selection criteria and assign the set of images, including the one or more identified features, to a training dataset in response to a determination that the set of images satisfies the one or more selection criteria; and training logic to retrain the machine-learning model using the training dataset.

In some embodiments of the above apparatus, the scientific instrument includes a charged particle microscope.

In some embodiments of any of the above apparatus, at least one of the image selection logic and the training logic is implemented by a computing device remote from the scientific instrument.

In some embodiments of any of the above apparatus, at least one of the image selection logic and the training logic is implemented in the scientific instrument.

In some embodiments of any of the above apparatus, the one or more identified features include line indicated termination features.

In some embodiments of any of the above apparatus, the image selection logic determines whether the set of images satisfies the one or more selection criteria by generating a metric for the one or more identified features, wherein the image selection logic determines that the set of images satisfies the one or more selection criteria in response to the metric satisfying a predetermined threshold.

In some embodiments of any of the above apparatus, the metric is based on a slope of at least one selected from a group consisting of a plot representing a number of features identified in each image in the set of images, a plot representing a feature area identified in each image in the set of images, and a plot representing feature distances for each image in the set of images.

In some embodiments of any of the above apparatus, the one or more selection criteria includes a predetermined reference for a characteristic of the one or more identified features and wherein the image selection logic determines whether the set of images satisfies the one or more selection criteria by identifying an anomaly of the one or more identified features as compared to the predetermined reference.

In some embodiments of any of the above apparatus, the predetermined reference for the characteristic of the one or more identified features includes at least one selected from a group consisting of a predetermined reference size of the one or more identified features, a predetermined reference number of the one or more identified features, a predetermined reference position of the one or more identified features, a predetermined reference shape of the one or more identified features, and a predetermined reference distance between two of the one or more identified features.

In some embodiments of any of the above apparatus, the image selection logic determines whether the set of images satisfies the one or more selection criteria by comparing the predetermined reference to the characteristic of the one or more identified features in a single image of the set of images.

In some embodiments of any of the above apparatus, the image selection logic determines whether the set of images satisfies the one or more selection criteria by comparing the predetermined reference to a representative characteristic of the one or more identified features in a plurality of images included in the set of images.

In some embodiments of any of the above apparatus, the representative characteristic includes at least one selected from a group consisting of an average of the characteristic in the plurality of images, a mean of the characteristic in the plurality of images, a median of the characteristic in the plurality of images, a standard deviation of the characteristic in the plurality of images, and a slope of a plot of the characteristic in the plurality of images.

In some embodiments of any of the above apparatus, the predetermined reference is user-defined.

In some embodiments of any of the above apparatus, the one or more selection criteria includes a characteristic of the one or more identified features and wherein the image selection logic determines whether the set of images satisfies the one or more selection criteria by identifying a pattern of the characteristic over multiple sets of images.

In some embodiments of any of the above apparatus, the characteristic of the one or more identified features includes at least one selected from a group consisting of a size of the one or more identified features, a number of the one or more identified features, a position of the one or more identified features, a shape of the one or more identified features, and a distance between two of the one or more identified features.

In some embodiments of any of the above apparatus, the pattern of the characteristic includes a change in the characteristic over the multiple sets of images.

In some embodiments of any of the above apparatus, the pattern of the characteristic includes a change in the characteristic over the multiple sets of images exceeding a predetermined threshold.

In some embodiments of any of the above apparatus, the predetermined threshold is user-defined.

In some embodiments of any of the above apparatus, the one or more selection criteria includes a user-defined rule based on a characteristic of the one or more identified features.

In some embodiments of any of the above apparatus, the one or more selection criteria includes a random selection.

In some embodiments of any of the above apparatus, the random selection defines a predetermined frequency for including the set of images in the training dataset.

In some embodiments of any of the above apparatus, the random selection is user-defined.

In some embodiments of any of the above apparatus, the one or more identified features include one or more first identified features of a first set of images and wherein the image selection logic excludes a second set of images, including one or more second identified features of the second set of images, from the training dataset.

In some embodiments of any of the above apparatus, the training dataset includes at least one selected from a group consisting of a retraining dataset, a testing dataset, a validation dataset, and an annotation dataset.

In some embodiments of any of the above apparatus, the training dataset includes an annotation dataset and wherein the image selection logic provides a user interface for receiving a user annotation for an image included in the annotation dataset.

In some embodiments of any of the above apparatus, the training dataset includes an annotation dataset and wherein the image selection logic provides a user interface and, in response to receiving an indication through the user interface, assign the set of images to at least one selected from a group consisting of a retraining dataset, a testing dataset, and a validation dataset.

In some embodiments of any of the above apparatus, the training dataset includes an annotation dataset and wherein the image selection logic provides a user interface and, in response to receiving an indication through the user interface, exclude the set of images from at least one selected from a group consisting of a retraining dataset, a testing dataset, and a validation dataset.

In some embodiments of any of the above apparatus, the training dataset includes an annotation dataset and wherein image selection logic, in response to assigning the set of images to the annotation dataset, generates and transmits a link selectable by a user to access the set of images assigned to the annotation dataset within a user interface.

In some embodiments of any of the above apparatus, the training logic retrains the machine-learning model using the training dataset in response to a triggering event.

In some embodiments of any of the above apparatus, the triggering event includes at least one selected from a group consisting of a number of user-annotated images included in the training dataset, an increase in a size of the training dataset, an increase in a number of user-annotated images for a predetermined feature in the training dataset, an availability of one or more training resources, and a manual initiation.

According to another example embodiment disclosed above, e.g., in reference to any one or any combination of some or all of FIGS. 1-20, provided is a method performed via a computing device for providing scientific instrument support, the method comprising: receiving one or more selection criteria; receiving one or more identified features in a set of images acquired via a scientific instrument, the one or more identified features generated using a machine-learning model; determining whether the set of images satisfies the one or more selection criteria; including the set of images, including the one or more identified features, in a training dataset in response to a determination that the set of images satisfies the one or more selection criteria; and retraining the machine-learning model using the training dataset.

In some embodiments of the above method, the one or more identified features in the set of images includes one or more first identified features in a first set of images, and the method further comprises receiving one or more second identified features in a second set of images acquired via the scientific instrument, the one or more second identified features generated using the machine-learning model; providing the first set of images and the one or more first identified features to a user interface; providing the second set of images and the one or more second identified features to the user interface; excluding the first set of images from the training dataset in response to a receiving a first indication through the user interface; and including the second set of images in the training dataset in response to receiving a second indication through the user interface.

In some embodiments of any of the above methods, the one or more selection criteria includes one or more first selection criteria and the one or more identified features of the set of images includes one or more first identified features of a first set of images, and the method further comprises receiving one or more second selection criteria; receiving one or more second identified features in a second set of images acquired via the scientific instrument, the one or more second identified features generated using the machine-learning model; determining whether the second set of images satisfies the one or more second selection criteria; and including the second set of images, including the one or more second identified features, in the training dataset in response to a determination that the second set of images satisfies the one or more second selection criteria.

In some embodiments of any of the above methods, the one or more identified features in the set of images includes one or more first identified features in a first set of images, and the method further comprises receiving one or more second identified features in a second set of images acquired via the scientific instrument, the one or more second identified features generated using the machine-learning model; providing the second set of images and the one or more second identified features to a user interface; receiving an annotation associated with the second set of images through the user interface; and including the second set of images, including the annotation, in the training dataset.

According to yet another example embodiment disclosed above, e.g., in reference to any one or any combination of some or all of FIGS. 1-20, provided are one or more non-transitory computer-readable media having instructions thereon that, when executed by one or more processing devices of a support apparatus for the scientific instrument, cause the support apparatus for perform any of the above methods.

According to another example embodiment disclosed above, e.g., in reference to any one or any combination of some or all of FIGS. 1-20, provided is an apparatus comprising: feature identification logic to, for each of a plurality of machine-learning models, generate one or more identified feature sets in a charged particle microscope image data set using the machine-learning model; model performance logic to, for each of the plurality of machine-learning models, generate one or more performance measurements; and model promotion logic to deploy, based on the performance measurements of the plurality of machine-learning models, a particular machine-learning model to a plurality of scientific instruments.

According to another example embodiment disclosed above, e.g., in reference to any one or any combination of some or all of FIGS. 1-20, provided is an apparatus comprising: feature identification logic to, for each of a plurality of machine-learning models, generate one or more identified feature sets in a charged particle microscope image data set using the machine-learning model; first interface logic to generate a first interface with first access permissions to display the charged particle microscope image data set and one or more of the identified feature sets; model performance logic to, for each of the plurality of machine-learning models, generate one or more performance measurements; and second interface logic to generate a second interface with second access permissions, different from the first access permissions, to display, for each of the plurality of machine-learning models, the one or more performance measurements.

According to another example embodiment disclosed above, e.g., in reference to any one or any combination of some or all of FIGS. 1-20, provided is an apparatus comprising: model promotion logic to receive a first indication of one or more model promotion criteria; and model performance logic to, for each of a plurality of machine-learning models, generate one or more performance measurements, wherein individual ones of the plurality of machine-learning models are to generate one or more identified feature sets in a charged particle microscope image data set; wherein the model promotion logic to deploy, based on the performance measurements of the plurality of machine-learning models and the model promotion criteria, a particular machine-learning model to a charged particle microscope for use in feature identification in subsequently acquired charged particle microscope image data sets.

Various features and advantages of the embodiments are set forth in the following claims.

What is claimed is:

1. A scientific instrument support apparatus, comprising:
feature identification logic to generate, using a machine-learning model, one or more identified features in an image of a set of images acquired via a scientific instrument;
image selection logic to determine whether the set of images satisfies one or more selection criteria and assign the set of images, including the one or more identified features, to a training dataset in response to a determination that the set of images satisfies the one or more selection criteria; and
training logic to retrain the machine-learning model using the training dataset.

2. The scientific instrument support apparatus of claim 1, wherein at least one of the image selection logic and the training logic is implemented by a computing device remote from the scientific instrument.

3. The scientific instrument support apparatus of claim 1, wherein the one or more identified features include line indicated termination features.

4. The scientific instrument support apparatus of claim 3, wherein the image selection logic determines whether the set of images satisfies the one or more selection criteria by generating a metric for the one or more identified features, wherein the image selection logic determines that the set of images satisfies the one or more selection criteria in response to the metric satisfying a predetermined threshold.

5. The scientific instrument support apparatus of claim 4, wherein the metric is based on a slope of at least one selected from a group consisting of a plot representing a number of features identified in each image in the set of images, a plot representing a feature area identified in each image in the set of images, and a plot representing feature distances for each image in the set of images.

6. The scientific instrument support apparatus of claim 1, wherein the one or more selection criteria includes a predetermined reference for a characteristic of the one or more identified features and wherein the image selection logic determines whether the set of images satisfies the one or more selection criteria by identifying an anomaly of the one or more identified features as compared to the predetermined reference.

7. The scientific instrument support apparatus of claim 6, wherein the predetermined reference for the characteristic of the one or more identified features includes at least one selected from a group consisting of a predetermined reference size of the one or more identified features, a predetermined reference number of the one or more identified features, a predetermined reference position of the one or more identified features, a predetermined reference shape of the one or more identified features, and a predetermined reference distance between two of the one or more identified features.

8. The scientific instrument support apparatus of claim 1, wherein the one or more selection criteria includes a characteristic of the one or more identified features and wherein the image selection logic determines whether the set of images satisfies the one or more selection criteria by identifying a pattern of the characteristic over multiple sets of images.

9. The scientific instrument support apparatus of claim 8, wherein the characteristic of the one or more identified features includes at least one selected from a group consisting of a size of the one or more identified features, a number of the one or more identified features, a position of the one or more identified features, a shape of the one or more identified features, and a distance between two of the one or more identified features.

10. The scientific instrument support apparatus of claim 1, wherein the one or more identified features include one or more first identified features of a first set of images and wherein the image selection logic excludes a second set of images, including one or more second identified features of the second set of images, from the training dataset.

11. The scientific instrument support apparatus of claim 1, wherein the training dataset includes an annotation dataset and wherein the image selection logic provides a user interface and, in response to receiving an indication through the user interface, assign the set of images to at least one selected from a group consisting of a retraining dataset, a testing dataset, and a validation dataset.

12. The scientific instrument support apparatus of claim 1, wherein the training dataset includes an annotation dataset and wherein the image selection logic provides a user interface and, in response to receiving an indication through the user interface, exclude the set of images from at least one selected from a group consisting of a retraining dataset, a testing dataset, and a validation dataset.

13. The scientific instrument support apparatus of claim 1, wherein the training dataset includes an annotation dataset and wherein image selection logic, in response to assigning the set of images to the annotation dataset, generates and transmits a link selectable by a user to access the set of images assigned to the annotation dataset within a user interface.

14. The scientific instrument support apparatus of claim 1, wherein the training logic retrains the machine-learning model using the training dataset in response to a triggering event.

15. The scientific instrument support apparatus of claim 14, wherein the triggering event includes at least one selected from a group consisting of a number of user-annotated images included in the training dataset, an increase in a size of the training dataset, an increase in a number of user-annotated images for a predetermined feature in the training dataset, an availability of one or more training resources, and a manual initiation.

16. A method performed via a computing device for providing scientific instrument support, the method comprising:
receiving one or more selection criteria;
receiving one or more identified features in a set of images acquired via a scientific instrument, the one or more identified features generated using a machine-learning model;
determining whether the set of images satisfies the one or more selection criteria;
including the set of images, including the one or more identified features, in a training dataset in response to a determination that the set of images satisfies the one or more selection criteria; and
retraining the machine-learning model using the training dataset.

17. The method of claim 16, wherein the one or more identified features in the set of images includes one or more first identified features in a first set of images and further comprising receiving one or more second identified features in a second set of images acquired via the scientific instrument, the one or more second identified features generated using the machine-learning model;
providing the first set of images and the one or more first identified features to a user interface;
providing the second set of images and the one or more second identified features to the user interface;
excluding the first set of images from the training dataset in response to a receiving a first indication through the user interface; and
including the second set of images in the training dataset in response to receiving a second indication through the user interface.

18. The method of claim 16, wherein the one or more selection criteria includes one or more first selection criteria and wherein the one or more identified features of the set of images includes one or more first identified features of a first set of images and further comprising receiving one or more second selection criteria;
receiving one or more second identified features in a second set of images acquired via the scientific instrument, the one or more second identified features generated using the machine-learning model;
determining whether the second set of images satisfies the one or more second selection criteria; and
including the second set of images, including the one or more second identified features, in the training dataset in response to a determination that the second set of images satisfies the one or more second selection criteria.

19. The method of claim 16, wherein the one or more identified features in the set of images includes one or more first identified features in a first set of images and further comprising
receiving one or more second identified features in a second set of images acquired via the scientific instrument, the one or more second identified features generated using the machine-learning model;
providing the second set of images and the one or more second identified features to a user interface;
receiving an annotation associated with the second set of images through the user interface; and
including the second set of images, including the annotation, in the training dataset.

20. One or more non-transitory computer-readable media having instructions thereon that, when executed by one or more processing devices of a support apparatus for the scientific instrument, cause the support apparatus to perform the method of claim 16.
